(19) United States
(12) Patent Application Publication
(10) Pub. No.: US 2026/0258284 A1
(43) Pub. Date: Sep. 3, 2026

(54) ADHESIVE TAPE, METHOD FOR MANUFACTURING HARD DISK DRIVE, AND HARD DISK DRIVE SEALING STRUCTURE

(71) Applicant: SEKISUI CHEMICAL CO., LTD., Osaka (JP)

(72) Inventor: Nobutaka YASUI, Shiga (JP)

(73) Assignee: SEKISUI CHEMICAL CO., LTD., Osaka (JP)

(21) Appl. No.: 19/159,748

(22) PCT Filed: May 29, 2024
(86) PCT No.: PCT/JP2024/019705

§ 371 Date: Aug. 26, 2025

(30) Foreign Application Priority Data
May 29, 2023 (JP) 2023-088112
May 29, 2023 (JP) 2023-088113

(51) Int. Cl. C09J 7/26; C09J 5/06; G11B 33/14

(52) U.S. Cl. CPC C09J 7/26; C09J 5/06; G11B 33/1466; C09J 2203/326; C09J 2301/312; C09J 2423/006

(57) ABSTRACT

An object of the present invention is to provide an adhesive tape excellent in barrier ability and L-shaped bending applicability. Another object of the present invention is to provide a method for manufacturing a hard disk drive excellent in sealability even in the case of sealing of a housing from the exterior of the housing, by use of the adhesive tape. Still another object of the present invention is to provide a hard disk drive sealing structure body sufficiently sealed even in the case of sealing of a housing from the exterior of the housing. The present invention relates to an adhesive tape having a water vapor transmission rate at 40° C. and 90% RH of 7.5 g/(m²·day) or 10 less, a bending rigidity at 25° C. at a bending width of 2.0 mm in at least one direction of a MD or a TD, of 1.0 N·mm² or less, and a 180° peel force against SUS at 23° C. of 5.0 N/25 mm or more.

### TECHNICAL FIELD

The present invention relates to an adhesive tape. The present invention also relates to a method for manufacturing a hard disk drive with the adhesive tape. The present invention further relates to a hard disk drive sealing structure body.

### BACKGROUND ART

An adhesive tape has a form in which an adhesive layer (pressure-sensitive adhesive layer) is provided on a substrate, and is widely used in various applications for the purposes of bonding, fixing, protecting, sealing, and the like. Such an adhesive tape is also utilized in electronic equipment applications, for example, in order to air-tightly seal the interior space of a magnetic disk apparatus. Prior art documents such as Patent Literature 1 to Patent Literature 4 disclose such an adhesive tape usable in electronic equipment applications.

### CITATION LIST

### Patent Literature

Patent Literature 1: JP 2019-163368 A
Patent Literature 2: WO 2021/106997
Patent Literature 3: WO 2020/218430
Patent Literature 4: JP H04-053841 A

### SUMMARY OF INVENTION

### Technical Problem

Conventionally, a gasket (sealant) has been provided in order to enclose helium gas in a housing in the course of manufacturing a hard disk drive (hereinafter, also referred to as “HDD”), but HDDs tend to include more and more platters (disks each coated with a magnetic material) to achieve a high capacity, and providing a space for sealing with a gasket in a housing has been increasingly difficult. Meanwhile, studies have been made on switching gasket sealing from the inside of a housing to sealing with an adhesive tape from the outside of a housing. In other words, if helium gas can be enclosed by applying an adhesive tape from the outside of a housing, a space can be ensured in such a housing and expansion of the HDD capacity can be promoted. In this application, such an adhesive tape is usually released after a helium gas-filling step.

In the case of such sealing with an adhesive tape from the outside of a housing, the adhesive tape needs to be folded into an L-shape and applied to the housing (L-shaped bending applicability) from the viewpoint of an enhancement in sealability. The housing is also desired to be sealed at one time by applying the adhesive tape to one surface of the housing and then pressing a mold against the housing to fold and apply the adhesive tape, in order to satisfy high productivity.

In recent years, a magnetic disk apparatus with HAMR (heat assist magnetic recording) adopted for a further increase in capacity has been progressively studied. HAMR is basically a technology for an increase in surface recording density with laser beam. This technology experiences laser attenuation in the presence of moisture in the system, which adversely affects the writing life. Therefore, penetration of moisture from the exterior is desirably eliminated as much as possible in HAMR.

An object of the present invention is to provide an adhesive tape excellent in barrier ability and L-shaped bending applicability. Another object of the present invention is to provide a method for manufacturing a hard disk drive excellent in sealability even in the case of sealing of a housing from the exterior of the housing, with the adhesive tape. Still another object of the present invention is to provide a hard disk drive sealing structure body sufficiently sealed even in the case of sealing of a housing from the exterior of the housing.

### Solution to Problem

The disclosure 1 relates to an adhesive tape having a water vapor transmission rate at 40° C. and 90% RH of 7.5 g/(m²·day) or less, a bending rigidity at 25° C. at a bending width of 2.0 mm in at least one direction of a MD or a TD, of 1.0 N·mm² or less, and a 180° peel force against SUS at 23° C. of 5.0 N/25 mm or more.

The disclosure 2 relates to the adhesive tape according to the disclosure 1, wherein the bending rigidity at 25° C. at a bending width of 2.0 mm in at least one direction of the MD or the TD is 0.45 N·mm² or less.

The disclosure 3 relates to the adhesive tape according to the disclosure 1 or 2, wherein the adhesive tape has a 10% thermal shrinkage temperature in at least one direction of the MD or the TD, of 95° C. or less.

The disclosure 4 relates to the adhesive tape according to the disclosure 1, 2, or 3, wherein the adhesive tape has two or more layers, the two or more layers include at least a first substrate layer and a first adhesive layer, and all the two or more layers of the adhesive tape satisfy that a product of a tensile storage elastic modulus at 25° C. and a thickness is 200 MPa·mm or less.

The disclosure 5 relates to the adhesive tape according to the disclosure 4, wherein the first substrate layer has a water vapor transmission rate at 40° C. and 90% RH of 40 g/(m²·day) or less.

The disclosure 6 relates to the adhesive tape according to the disclosure 4 or 5, wherein the first substrate layer contains a foam.

The disclosure 7 relates to the adhesive tape according to the disclosure 6, wherein the foam includes a polyolefin foam.

The disclosure 8 relates to the adhesive tape according to the disclosure 4, 5, 6, or 7, wherein the first substrate layer has a 10% thermal shrinkage temperature in at least one direction of a MD or a TD, of 95° C. or less.

The disclosure 9 relates to the adhesive tape according to the disclosure 8, wherein the first substrate layer has a 10% thermal shrinkage temperature in each of the MD and the TD, of 95° C. or less.

The disclosure 10 relates to the adhesive tape according to the disclosure 4, 5, 6, 7, 8, or 9, wherein the adhesive tape has the first substrate layer, the first adhesive layer, a second substrate layer, and a second adhesive layer in the listed order, the first substrate layer contains a foam, the first substrate layer has a water vapor transmission rate at 40° C. and 90% RH of 40 g/(m²·day) or less, the first substrate layer satisfies that a product of an average value of tensile storage elastic moduli at 25° C. in a MD and a TD and a thickness is 50 MPa·mm or less, and the second substrate layer has a 10% thermal shrinkage temperature in at least one direction of a MD or a TD, of 95° C. or less.

The disclosure 11 relates to the adhesive tape according to the disclosure 4, 5, 6, 7, 8, 9, or 10, further having an inorganic layer.

The disclosure 12 relates to the adhesive tape according to the disclosure 1, 2, 3, 4, 5, 6, 7, 8, 9, 10, or 11, wherein the adhesive tape has a thickness of 0.20 mm or more.

The disclosure 13 relates to a method for manufacturing a hard disk drive having a body including a hard disk and a lid, the method including a step of sealing the hard disk drive by applying the adhesive tape according to the disclosure 1, 2, 3, 4, 5, 6, 7, 8, 9, 10, 11, or 12 to the body and the lid.

The disclosure 14 relates to the method for manufacturing a hard disk drive according to the disclosure 13, wherein the step of sealing the hard disk drive includes folding and applying the adhesive tape from the lid to the body and then thermally shrinking the adhesive tape.

The disclosure 15 relates to the method for manufacturing a hard disk drive according to the disclosure 14, wherein the body includes a body bottom and a body side wall projected upward from the body bottom, the lid has a structure so as to be attached onto the body side wall of the body, and the step of sealing the hard disk drive includes a step (I) of folding and applying the adhesive tape from the lid to the body side wall, and a step (II) of thermally shrinking the adhesive tape after the step (I).

The disclosure 16 relates to the method for manufacturing a hard disk drive according to the disclosure 15, wherein the body has a body corner on a surface of the body side wall, the surface being for attachment of the lid, the lid has a lid corner to contact the body corner, and the step (I) includes folding and applying the adhesive tape at least from the lid corner to the body corner and the step (II) includes thermally shrinking a portion of the adhesive tape, the portion being applied from the lid corner to the body corner.

The disclosure 17 relates to the method for manufacturing a hard disk drive according to the disclosure 15 or 16, wherein the step (I) includes attaching the lid onto the body side wall, attaching the adhesive tape to an outer circumferential edge of an upper surface of the lid so that a portion of the adhesive tape is located outside the outer circumferential edge of the upper surface of the lid, and pressing a mold against the lid, the mold containing a mold bottom and a mold side wall projected downward from an outer circumferential edge of the mold bottom, so that the upper surface of the lid and a lower surface of the mold bottom face each other, and folding the adhesive tape so that a portion of the adhesive tape, the portion being not in contact with the upper surface of the lid, is located between the mold side wall and the body side wall, to apply the adhesive tape to the body side wall, thereby bonding the body and the lid together.

The disclosure 18 relates to the method for manufacturing a hard disk drive according to the disclosure 17, wherein, when the pressing is performed so that the upper surface of the lid and the lower surface of the mold bottom face each other, the mold is warmed to 35° C. or more and 60° C. or less and then used.

The disclosure 19 relates to the method for manufacturing a hard disk drive according to the disclosure 15, 16, 17, or 18, wherein, in the step (I), the adhesive tape is in a frame form having a shape corresponding to an outer circumferential edge of an upper surface of the lid and an outer frame of the adhesive tape in the frame form is attached so as to be located outside the outer circumferential edge of the upper surface of the lid.

The disclosure 20 relates to the method for manufacturing a hard disk drive according to the disclosure 15, 16, 17, 18, or 19, wherein the step (II) includes thermally shrinking the adhesive tape by 10% or more in at least one direction of the MD or the TD at a temperature of the adhesive tape of 95° C. or less.

The disclosure 21 relates to a hard disk drive sealing structure body including a body and a lid, the body and the lid being fixed with an adhesive tape interposed therebetween, the adhesive tape being thermally shrunk.

Hereinafter, the present invention is described in detail.

The present inventors have studied adjustment of the water vapor transmission rate, the bending rigidity in at least one direction of the MD or the TD, the 180° peel force against SUS, and the thickness of an adhesive tape to respective appropriate ranges. As a result, the inventors have found that an adhesive tape excellent in barrier ability and L-shaped bending applicability can be obtained, thereby leading to completion of the present invention.

Herein, the “L-shaped” means a folded state and does not mean only a perpendicularly folded state, and also encompasses a state in which folding is made twice or more.

The upper limit of the water vapor transmission rate at 40° C. and 90% RH of the adhesive tape of the present invention is 7.5 g/m²·day. The water vapor transmission rate at 40° C. and 90% RH of the adhesive tape of the present invention is 7.5 g/(m²·day) or less, and thus the resulting adhesive tape is excellent in barrier ability. The upper limit of the water vapor transmission rate at 40° C. and 90% RH of the adhesive tape of the present invention is preferably 5.0 g/(m²·day), more preferably 3.0 g/(m²·day), further preferably 2.0 g/(m²·day), particularly preferably 1.0 g/(m²·day), most preferably 0.5 g/(m²·day).

A preferred lower limit of the water vapor transmission rate at 40° C. and 90% RH of the adhesive tape of the present invention is not limited, and the lower limit is substantially about 0.1 g/(m²·day).

Herein, the water vapor transmission rate at 40° C. and 90% RH can be measured, for example, by measuring the water vapor transmission rate in the thickness direction of the adhesive tape in conditions of 40° C. and 90% RH with a water vapor transmittance measurement apparatus (for example, “PERMATRAN-W” available from MOCON Inc.) according to the method of JIS K 7129 B.

Examples of the method for adjusting the water vapor transmission rate at 40° C. and 90% RH of the adhesive tape of the present invention in the above range include a method for adjusting the water vapor transmission rate of a substrate layer of an adhesive tape described below or the adhesive layer, and a method of adding another substrate layer or adhesive layer.

The upper limit of the bending rigidity at 25° C. at a bending width of 2.0 mm in at least one direction of the MD or the TD of the adhesive tape of the present invention (hereinafter, also sometimes simply referred to as “bending rigidity”.) is 1.0 N·mm². The bending rigidity in at least one direction of the MD or the TD of the adhesive tape of the present invention is 1.0 N·mm² or less, thus a folded state is easily kept, peeling from an adherend can be suppressed even in the case of folding and then application, and the resulting adhesive tape is excellent in L-shaped bending applicability. The bending rigidity in at least one direction of the MD or the TD of the adhesive tape of the present invention is 1.0 N·mm² or less, thus thermal shrinkage described below is hardly inhibited in the case of such thermal shrinkage performed, and shrinkage at a lower temperature is facilitated. The upper limit of the bending rigidity in at least one direction of the MD or the TD of the adhesive tape of the present invention is preferably 0.45 N·mm², more preferably 0.30 N·mm².

The lower limit of the bending rigidity in at least one direction of the MD or the TD of the adhesive tape of the present invention is preferably 0.003 N·mm². The bending rigidity in at least one direction of the MD or the TD of the adhesive tape of the present invention is 0.003 N·mm² or more, and thus application without wrinkles is facilitated, thereby resulting in an enhancement in sealability.

The lower limit of the bending rigidity in at least one direction of the MD or the TD of the adhesive tape of the present invention is more preferably 0.006 N·mm², further preferably 0.01 N·mm².

Herein, the “MD” means a machine direction, namely, a flow direction during manufacturing, and the “TD” means a transverse direction, namely, a direction perpendicular to the MD. In a case where the flow direction during manufacturing is not clear, the longitudinal direction of the adhesive tape is defined as “MD”, and in a case where the adhesive tape is a square or the like and no longitudinal direction is present, the direction of any one side is defined as “MD”.

The bending rigidity of the adhesive tape of the present invention is calculated by the following expression (1), as the bending rigidity in the case of bending with an adhesive layer as the outermost surface of the adhesive tape being located inward as in the right drawing in FIG. 1.

$$\begin{matrix}[ Math . 1 ] & \\ EI = {\sum }_{i = 1}^{n} {E}_{i} {I}_{i} = \frac{b}{3} {\sum }_{i = 1}^{n} {E}_{i} \{ {( {h}_{i} - λ )}^{3} - {( {h}_{i - 1} - λ )}^{3} \} & ( 1 )\end{matrix}$$

In the expression (1), Eᵢ represents the tensile storage elastic modulus (MPa) at 25° C. of the i-th layer from the outermost surface located inside, Iᵢ represents the second moment of area (mm⁴) of the i-th layer from the outermost surface, b represents the bending width (mm), hi represents the total of thickness (mm) from the layer as the outermost surface located inside to the i-th layer, and 2 represents the distance (mm) from the neutral axis to the outermost surface of the adhesive tape, as calculated by the following expression (2).

$$\begin{matrix}[ Math . 2 ] & \\ λ = \frac{{\sum }_{i = 1}^{n} {E}_{i} ( {h}_{i}^{2} - {h}_{i - 1}^{2} )}{2 {\sum }_{i = 1}^{n} {E}_{i} {t}_{i}} & ( 2 )\end{matrix}$$

In the expression (2), Eᵢ represents the tensile storage elastic modulus (MPa) at 25° C. of the i-th layer from the outermost surface located inside, hi represents the total of thickness (mm) from the layer as the outermost surface located inside to the i-th layer, and tᵢ represents the thickness (mm) of the i-th layer from the outermost surface located inside.

Examples of the method for adjusting the bending rigidity of the adhesive tape of the present invention in the above range include a method including using the adhesive tape with a substrate, a method including adjusting the thickness of the adhesive tape, a method including adjusting the tensile storage elastic modulus of each layer such as a substrate layer or an adhesive layer constituting the adhesive tape, a method including modifying the thickness of each layer constituting the adhesive tape, and a method including modifying the order of laminating of respective layers constituting the adhesive tape.

The lower limit of the 180° peel force against SUS at 23° C. of the adhesive tape of the present invention (hereinafter, also simply referred to as “180° peel force”) is 5.0 N/25 mm. The 180° peel force of the adhesive tape of the present invention is 5.0 N/25 mm or more, and thus the resulting adhesive tape has high adhesion and is enhanced in L-shaped bending applicability. The lower limit of the 180° peel force of the adhesive tape of the present invention is preferably 7.0 N/25 mm, more preferably 9.0 N/25 mm.

The upper limit of the 180° peel force of the adhesive tape of the present invention is preferably 30 N/25 mm. When the 180° peel force of the adhesive tape of the present invention is 30 N/25 mm or less, the resulting adhesive tape is more enhanced in releasability and can be more suitably used in a method for manufacturing an HDD described below. The upper limit of the 180° peel force of the adhesive tape of the present invention is more preferably 20 N/25 mm, further preferably 10 N/25 mm.

The 180° peel force against SUS at 23° C. of the adhesive tape of the present invention can be measured by, for example, the following method.

Specifically, first, the 180° peel force can be measured by cutting the adhesive tape into a plane rectangle shape of 25 mm width×150 mm length, pressure-bonding the cut adhesive tape to a SUS304 plate (washed with ethanol and then dry-wiped before use) subjected to surface 2B-finishing prescribed in JIS G 4305, by reciprocating a 2-kg rubber roller twice at a rate of 10 mm/sec with under an environment at 23° C. and 50% RH, furthermore, leaving the resultant to stand under an environment at 23° C. and 50% RH for 20 minutes, and then peeling the adhesive tape from the SUS plate in a 180° peel test performed according to JIS Z 0237 with a tensile tester (for example, “AGS-X” available from Shimadzu Corporation) under conditions of 23° C., 50% RH, and a peeling rate of 300 mm/min.

Examples of the method for adjusting the 180° peel force against SUS at 23° C. of the adhesive tape of the present invention, in the above range, include a method including modifying an adhesive of an adhesive layer, a method including adjusting the thickness of the adhesive tape, and a method including modifying the material of a substrate layer.

The lower limit of the thickness of the adhesive tape of the present invention is 0.20 mm. The thickness of the adhesive tape of the present invention is 0.20 mm or more, thus the adhesive tape can more closely adhere to an adherend, sufficient adhesiveness is obtained in pressing of the mold and then folding and applying of the adhesive tape, and also the resulting adhesive tape advantageously ensures barrier ability. The lower limit of the thickness of the adhesive tape of the present invention is preferably 0.30 mm, more preferably 0.40 mm.

The preferable upper limit of the thickness of the adhesive tape of the present invention is 2.4 mm. When the thickness of the adhesive tape of the present invention is 2.4 mm or less, the bending rigidity is easily lowered. The upper limit of the thickness of the adhesive tape of the present invention is more preferably 1.5 mm, further preferably 1.0 mm.

Examples of the method for measuring the thickness here include a method of measurement with a dial thickness meter (for example, “ABS digimatic indicator” available from Mitutoyo Corporation) and a method for measuring the thickness of each layer of the adhesive tape from an image taken by photographing a cross section of the adhesive tape with a digital microscope (for example, “VHX-900” available from Keyence Corporation).

The adhesive tape of the present invention preferably has two or more layers. The adhesive tape of the present invention, when having two or more layers, has a moderate thickness and therefore more closely adheres to an adherend and is more excellent in barrier ability.

The two or more layers preferably include at least a first substrate layer and a first adhesive layer. When the adhesive tape of the present invention has a first substrate layer and a first adhesive layer, the resulting adhesive tape has moderate stiffness and therefore is more excellent in L-shaped bending applicability.

The preferable upper limit of the product of the tensile storage elastic modulus at 25° C. and the thickness (hereinafter, also simply referred to “product of the tensile storage elastic modulus and the thickness”.) in all the two or more layers of the adhesive tape of the present invention is 200 MPa·mm. When all the two or more layers of the adhesive tape of the present invention satisfy that a product of the tensile storage elastic modulus and the thickness is 200 MPa·mm or less, the resulting adhesive tape is more enhanced in flexibility and more enhanced in L-shaped bending applicability. The upper limit of the product of the tensile storage elastic modulus and the thickness is more preferably 50 MPa·mm, further preferably 25 MPa·mm.

A preferred lower limit of the product of the tensile storage elastic modulus and the thickness is not limited, and the lower limit is substantially about 0.01 MPa·mm.

In a case where the layer for calculation of the product of the tensile storage elastic modulus and the thickness is the substrate layer, the average value of the tensile storage elastic moduli at 25° C. in the MD and the TD is used as the tensile storage elastic modulus at 25° C.

The first substrate layer preferably contains a foam. When the first substrate layer contains a foam, the first substrate layer has moderate flexibility and thus the bending rigidity of the adhesive tape of the present invention is easily adjusted in the above range and L-shaped bending applicability is more enhanced. The tensile storage elastic modulus of the first substrate layer, described below, is easily adjusted in an appropriate range.

Examples of the foam include a polyurethane foam, a polyolefin foam, a rubber foam, and an acrylic foam. In particular, a polyolefin foam is preferred from the viewpoint that the water vapor transmission rate at 40° C. and 90% RH of the first substrate layer, described below, can be easily adjusted in an appropriate range and the resulting adhesive tape is more enhanced in barrier ability, and from the viewpoint that the first substrate layer has moderate flexibility and the bending rigidity of the resulting adhesive tape is easily adjusted in the above range and L-shaped bending applicability is more enhanced. In other words, the foam preferably includes a polyolefin foam.

Examples of the polyolefin foam include any foam containing a polyethylene resin, a polypropylene resin, an ethylene-vinyl acetate copolymer, or an ethylene-ethyl acrylate copolymer. In particular, a foam containing a polyethylene resin is preferred from the viewpoint that the first substrate layer has moderate flexibility.

Specific examples of the polyethylene resin include a polyethylene resin obtained by polymerization with a catalyst such as a Ziegler Natta compound, a metallocene catalyst, or a chromium oxide compound, and in particular, a polyethylene resin obtained by polymerization with a metallocene catalyst is preferred from the viewpoint of releasability due to an enhancement in strength of the polyethylene resin.

Examples of the metallocene catalyst can include a bis(cyclopentadienyl) metal complex having a structure in which a transition metal is sandwiched between x-electron system unsaturated compounds. More specific examples can include a compound in which one, or two or more cyclopentadienyl rings or any analog(s) thereof is/are present as ligands on any of tetravalent transition metals such as titanium, zirconium, nickel, palladium, hafnium, and platinum.

Such a metallocene catalyst has active sites uniform in terms of properties and each of such active sites has the same activity. Polymers synthesized with such a metallocene catalyst are uniform in terms of molecular weight, molecular weight distribution, compositional ratio, compositional distribution, and the like, and therefore, when a sheet containing a polymer synthesized with such a metallocene catalyst is crosslinked, this crosslinking uniformly progresses.

Examples of the ligand can include cyclic compounds such as a cyclopentadienyl ring and an indenyl ring. Such a cyclic compound is optionally substituted with a hydrocarbon group, a substituted-hydrocarbon group, a hydrocarbon-substituted metalloid group, or the like.

Examples of the hydrocarbon group include a methyl group, an ethyl group, a n-propyl group, a isopropyl group, a n-butyl group, a sec-butyl group, a tert-butyl group, a n-pentyl group, a n-hexyl group, a 2-ethylhexyl group, a n-heptyl group, a n-octyl group, a n-nonyl group, and a phenyl group.

The ligand used here may also be a ligand obtained by polymerization of the cyclic compound into an oligomer.

Not only a x-electron system unsaturated compound, but also a monovalent anion ligand or a divalent anion chelate ligand of chlorine, bromine, or the like, hydrocarbon, alkoxide, arylamide, aryl oxide, amide, arylamide, phosphide, aryl phosphide, or the like may be used.

Examples of the metallocene catalyst containing a tetravalent transition metal or ligand include cyclopentadienyltitanium tris(dimethylamide), methylcyclopentadienyltitanium tris(dimethylamide), bis(cyclopentadienyl) titanium dichloride, and dimethylsilyltetramethylcyclopentadienyl-t-butylamide zirconium dichloride.

The metallocene catalyst is combined with a specified co-catalyst (promoter), thereby exerting the effect of catalyst during polymerization of various olefins. Examples of the co-catalyst include methylaluminoxane (MAO) and a boron compound. The proportion of the co-catalyst used with respect to the metallocene catalyst is preferably 10 times to 1,000,000 times by mol, more preferably 50 times to 5000 times by mol.

Examples of the polyethylene resin obtained by polymerization include low-density polyethylene (density: less than 0.930 g/cm³), moderate-density polyethylene (density: 0.930 g/cm³ or more and less than 0.942 g/cm³), and high-density polyethylene (density: 0.942 g/cm³ or more).

The low-density polyethylene resin is preferably linear low-density polyethylene. The linear low-density polyethylene is more preferably linear low-density polyethylene obtained by copolymerization of ethylene (for example, 75% by mass or more, preferably 90% by mass or more based on the amount of all monomers) with, if necessary, a small amount of an α-olefin.

Specific examples of the α-olefin include propylene, 1-butene, 1-pentene, 4-methyl-1-pentene, 1-hexene, 1-heptene, and 1-octene. In particular, a C4-C₁₀ α-olefin is preferred from the viewpoints of a low tensile storage elastic modulus and productivity.

The density of the polyethylene resin, for example, the linear low-density polyethylene is preferably 0.870 g/cm³ to 0.925 g/cm³, more preferably 0.890 g/cm³ to 0.925 g/cm³, further preferably 0.910 g/cm³ to 0.925 g/cm³ from the viewpoint of flexibility. A plurality of such polyethylene resins can be used, or any other polyethylene resin having a density out of the above range may also be added.

Furthermore, the high-density polyethylene is preferably used or the high-density polyethylene and the low-density polyethylene are preferably used in combination from the viewpoint of barrier ability.

Examples of the polypropylene resin include homopolypropylene, and a propylene-α-olefin copolymer containing 50% by mass or more of propylene. Specific examples of the α-olefin constituting the propylene-α-olefin copolymer include ethylene, 1-butene, 1-pentene, 4-methyl-1-pentene, 1-hexene, 1-heptene, and 1-octene. In particular, a C6-C12 α-olefin is preferred from the viewpoints of barrier ability and productivity.

Such polypropylene resins may be used singly or in combinations of two or more kinds thereof.

The lower limit of the proportion of the foam contained in the first substrate layer is preferably 70% by mass, more preferably 80% by mass, further preferably 90% by mass.

The first substrate layer may further, if necessary, contain any additive such as a heat stabilizer, a colorant, a flame retardant, an antistatic agent, a filling agent, and/or a filler or a layered clay mineral having a function of increasing barrier ability.

The first substrate layer may also be crosslinked by ionizing radiation or the like.

The method for producing the first substrate layer can be, for example, a method including charging a foaming composition containing the polyethylene resin and a foaming agent to an extruder, melt-kneading the composition, and then extruding the composition.

The foaming agent is preferably a heat-decomposable foaming agent from the viewpoint of productivity. The heat-decomposable foaming agent used here can be an organic foaming agent or an inorganic foaming agent.

Examples of the organic foaming agent include azo compounds such as azodicarbonamide, an azodicarboxylic acid metal salt (such as barium azodicarboxylate) and azobisisobutyronitrile, nitroso compounds such as N,N′-dinitrosopentamethylenetetramine, hydrazine derivatives such as hydrazodicarbonamide, 4,4′-oxybis(benzenesulfonylhydrazide) and toluenesulfonylhydrazide, and semicarbazide compounds such as toluenesulfonyl semicarbazide.

Examples of the inorganic foaming agent include ammonium carbonate, sodium carbonate, ammonium hydrogen carbonate, sodium hydrogen carbonate, ammonium nitrite, sodium borohydride, and monosodium citric anhydride.

In particular, an azo compound is preferred and azodicarbonamide is more preferred from the viewpoint of providing fine air bubbles and from the viewpoints of economy and safety.

Such heat-decomposable foaming agents may be used singly or in combinations of two or more kinds thereof.

A decomposition temperature modifier may be compounded into the above foamable resin composition from the viewpoint of lowering the decomposition temperature of the heat-decomposable foaming agent and/or increasing the decomposition rate thereof. Examples of the decomposition temperature modifier include zinc oxide, zinc stearate, and urea.

An antioxidant may be compounded into the above foamable resin composition. Examples of the antioxidant include a phenolic antioxidant such as 2,6-di-t-butyl-p-cresol, a sulfur antioxidant, a phosphorus antioxidant, and an amine antioxidant.

The lower limit of the density of the first substrate layer is preferably 0.01 kg/m³, and the upper limit thereof is preferably 0.8 kg/m³. When the density of the first substrate layer falls within the above range, the resulting adhesive tape has more excellent barrier ability and more excellent L-shaped bending applicability. The lower limit of the density of the first substrate layer is more preferably 0.05 kg/m³ and the upper limit thereof is more preferably 0.6 kg/m³, and the lower limit is further preferably 0.1 kg/m³ and the upper limit is further preferably 0.3 kg/m³.

The density of the first substrate layer means the apparent density, and can be measured with, for example, an electronic hydrometer (for example, “EDM series” available from AS ONE Corporation) by a water displacement method, according to JIS K 7222.

Examples of the method for adjusting the density of the first substrate layer include a method including adjusting the type and the amount of the foaming agent contained in the foaming composition, and a method including adjusting the foaming temperature.

The upper limit of the water vapor transmission rate at 40° C. and 90% RH of the first substrate layer is preferably 40 g/(m²·day). When the water vapor transmission rate at 40° C. and 90% RH of the first substrate layer is 40 g/(m²·day) or less, the resulting adhesive tape is more enhanced in barrier ability. The upper limit of the water vapor transmission rate at 40° C. and 90% RH of the first substrate layer is more preferably 21 g/(m²·day), further preferably 1.0 g/(m²·day).

A preferred lower limit of the water vapor transmission rate at 40° C. and 90% RH of the first substrate layer is not limited, and the lower limit is substantially about 0.1 g/(m²·day).

Examples of the method for adjusting the water vapor transmission rate at 40° C. and 90% RH of the first substrate layer include a method including modifying the thickness of the substrate layer, a method including modifying the material of the substrate layer, a method including modifying the foaming ratio in the case of the substrate layer as a foam, a method including allowing the substrate layer to contain an inorganic mineral, and a method including laminating an inorganic layer on the substrate layer.

The foaming ratio is determined by measuring the apparent density and calculating the reciprocal number thereof. The apparent density can be measured according to JIS K 7222.

The upper limit of the 10% thermal shrinkage temperature in at least one direction of the MD or the TD of the first substrate layer is preferably 95° C. When the 10% thermal shrinkage temperature in at least one direction of the MD or the TD of the first substrate layer is 95° C. or less, the resulting adhesive tape can be more suitably used in a method for manufacturing an HDD described below. The upper limit of the 10% thermal shrinkage temperature in at least one direction of the MD or the TD of the first substrate layer is more preferably 80° C., further preferably 70° C., particularly preferably 60° C. The 10% thermal shrinkage temperature in each of the MD or the TD of the first substrate layer is more preferably 95° C. or less.

The lower limit of the 10% thermal shrinkage temperature in at least one direction of the MD or the TD of the first substrate layer is preferably 40° C. When the 10% thermal shrinkage temperature in at least one direction of the MD or the TD of the first substrate layer is 40° C. or more, the adhesive tape can be stored at ordinary temperature. The lower limit of the 10% thermal shrinkage temperature in at least one direction of the MD or the TD of the first substrate layer is more preferably 50° C., further preferably 60° C.

Herein, the 10% thermal shrinkage temperature can be measured by the following method.

Specifically, first, the substrate layer and the adhesive tape to be measured are each cut into a plane square of 50 mm width×50 mm length, to produce a test piece. The test piece obtained is immersed for 10 seconds in about 1 L of water heated to 50° C. in advance, and then air-cooled to room temperature, the width and the length of the test piece air-cooled are measured, and the width and the length measured are used to provide the thermal shrinkage rate at 50° C. in each of the MD and the TD by the following expression (3). The test piece is similarly immersed in water at each of 60° C., 70° C., 80° C., 90° C., and 100° C., and cooled to room temperature, and thereafter the width and the length thereof are measured and these are used to provide the thermal shrinkage rate at each of 60° C., 70° C., 80° C., 90° C., and 100° C. in each of the MD and the TD by the following expression (3). Based on the obtained thermal shrinkage rate, the 10% thermal shrinkage is determined as follows: a case where the thermal shrinkage rate at 50° C. is more than 10% corresponds to a 10% thermal shrinkage temperature of less than 50° C.; a case where the thermal shrinkage rate at 100° C. is less than 10% corresponds to a 10% thermal shrinkage temperature of more than 100° C.; and in any other cases, the temperature and the thermal shrinkage rate are assumed to be proportional to each other between the maximum temperature at which the thermal shrinkage rate is less than 10% and the minimum temperature at which the thermal shrinkage rate is more than 10%, and the 10% thermal shrinkage temperature is calculated.

$$Thermal shrinkage rate ( \% ) = [ ( {L}_{0} - {L}_{1} ) / {L}_{0} ] \times 100 \qquad ( 3 )$$

(L₀: dimension of adhesive tape before immersion in water, L₁: dimension of adhesive tape after immersion in heated water and then air-cooling to room temperature) Examples of the method for adjusting the 10% thermal shrinkage temperature of the first substrate layer include a method including modifying the drawing ratio and a method including modifying the material of the substrate layer.

The lower limit of the tensile storage elastic modulus at 25° C. in at least one direction of the MD or the TD of the first substrate layer is preferably 0.1 MPa and the upper limit thereof is preferably 200 MPa. When the tensile storage elastic modulus at 25° C. in at least one direction of the MD or the TD of the first substrate layer falls within the above range, the product of the average value of the tensile storage elastic modii in the MD and the TD of the first substrate layer and the thickness is easily adjusted in the above range and the resulting adhesive tape is more enhanced in L-shaped bending applicability. The lower limit of the tensile storage elastic modulus at 25° C. in at least one direction of the MD or the TD of the first substrate layer is more preferably 1 MPa and the upper limit thereof is more preferably 80 MPa, and the lower limit is further preferably 5 MPa and the upper limit is further preferably 40 MPa.

The tensile storage elastic modulus at 25° C. of the first substrate layer can be obtained by measurement with a dynamic viscoelasticity measurement apparatus (“DVA-200” available from IT Measurement & Control Co., Ltd.) under conditions of a measurement mode of tensile, 25° C., a frequency of 1 Hz, a rate of temperature rise of 5° C./min, a temperature range of 0° C. to 100° C., and a set strain of 0.1%.

Examples of the method for adjusting the tensile storage elastic modulus at 25° C. of the first substrate layer include a method including modifying the foaming ratio and a method including modifying the material of the substrate layer.

The lower limit of the thickness of the first substrate layer is preferably 100 μm, and the upper limit thereof is preferably 2000 μm. When the thickness of the first substrate layer falls within the above range, the resulting adhesive tape has more excellent barrier ability and more excellent L-shaped bending applicability. The lower limit of the thickness of the first substrate layer is more preferably 150 μm and the upper limit thereof is more preferably 1000 μm, and the lower limit is further preferably 200 μm and the upper limit is further preferably 500 μm.

Examples of the first adhesive layer include an adhesive layer containing an adhesive such as an acrylic adhesive, a rubber adhesive, a urethane adhesive, or a silicone adhesive. In particular, an acrylic adhesive is preferred from the viewpoint of an enhancement in L-shaped bending applicability of the resulting adhesive tape. A rubber adhesive is preferred from the viewpoint of an easy reduction in water vapor transmission rate.

The acrylic adhesive contains a (meth)acrylic copolymer.

The (meth)acrylic copolymer preferably contains a (meth)acrylic acid alkyl ester having a C1-C18 alkyl group at an ester end.

Examples of the (meth)acrylic acid alkyl ester having a C1-C18 alkyl group at an ester end include methyl (meth)acrylate, ethyl (meth)acrylate, n-propyl (meth)acrylate, isopropyl (meth)acrylate, n-butyl (meth)acrylate, n-heptyl (meth)acrylate, n-octyl (meth)acrylate, 2-ethylhexyl (meth)acrylate, tridecyl methacrylate, and stearyl (meth)acrylate. In particular, n-butyl acrylate or 2-ethylhexyl acrylate is preferred from the viewpoint of easy control of adhesion. Such (meth)acrylic acid alkyl esters may be used singly or in combinations of two or more kinds thereof.

Herein, the “(meth)acrylic” means acrylic or methacrylic.

The (meth)acrylic copolymer may contain, if necessary, a structural unit derived from any other copolymerizable monomer.

Examples of such other copolymerizable monomer include hydroxyalkyl (meth)acrylate, glycerin dimethacrylate, glycidyl (meth)acrylate, 2-methacryloyloxyethyl isocyanate, (meth)acrylic acid, itaconic acid, maleic anhydride, crotonic acid, maleic acid, and fumaric acid. In particular, a functional monomer having a polar functional group such as a hydroxy group or a carboxy group is preferred because the gel fraction of the first adhesive layer is easily adjusted by formation of a crosslinked structure with a crosslinking agent.

Such other copolymerizable monomers may be used singly or in combinations of two or more kinds thereof.

The lower limit of the weight average molecular weight (Mw) of the (meth)acrylic copolymer is preferably 300,000 and the upper limit thereof is preferably 2,000,000. When the weight average molecular weight of the (meth)acrylic copolymer falls within the above range, the first adhesive layer has moderate hardness and exhibits sufficient cohesion, and the resulting adhesive tape has higher adhesion and thus is more enhanced in L-shaped bending applicability. The lower limit of the weight average molecular weight of the (meth)acrylic copolymer is more preferably 500,000 and the upper limit thereof is more preferably 1,400,000, and the lower limit is further preferably 600,000 and the upper limit is further preferably 1,300,000.

The lower limit of the ratio (molecular weight distribution, Mw/Mn) of the weight average molecular weight (Mw) to the number average molecular weight (Mn) of the (meth)acrylic copolymer is preferably 1.05 and the upper limit thereof is preferably 10.0. When the molecular weight distribution (Mw/Mn) of the (meth)acrylic copolymer falls within the above range, the amount of a low-molecular weight component or the like is decreased and therefore the first adhesive layer is more enhanced in cohesion and the resulting adhesive tape has high adhesion. The lower limit of the molecular weight distribution (Mw/Mn) of the (meth)acrylic copolymer is more preferably 1.1 and the upper limit thereof is more preferably 8.0, and the lower limit is further preferably 1.2 and the upper limit is further preferably 5.0.

Herein, the number average molecular weight (Mn) and the weight average molecular weight (Mw) are each the molecular weight in terms of standard polystyrene determined by GPC (Gel Permeation Chromatography). In GPC, for example, 2690 Separations Model (available from Waters Corporation) can be used. A GPC apparatus (for example, “HLC-8220” available from Tosoh Corporation, column: TSKgelSurper HZM-N (4 columns)) or the like can also be used, tetrahydrofuran can be used as the solvent, and measurement conditions such as 40° C. and a flow rate of 0.5 mL/min can be adopted.

In order to adjust the weight average molecular weight and the molecular weight distribution (Mw/Mn) of the (meth)acrylic copolymer in the above ranges, polymerization conditions such as a polymerization initiator and a polymerization temperature may be adjusted.

In order to obtain the (meth)acrylic copolymer, the monomer mixture may be subjected to a radical reaction in the presence of a polymerization initiator. The method for the radical reaction of the monomer mixture, namely, the polymerization method, may be a conventionally known method such as solution polymerization (boiling-point polymerization or constant-temperature polymerization), emulsion polymerization, suspension polymerization, or bulk polymerization. Examples of the reaction manner in the radical reaction of the monomer mixture include living radical polymerization and free radical polymerization.

Examples of the polymerization initiator include organic peroxide and an azo compound.

Examples of the organic peroxide include 1,1-bis(t-hexylperoxy)-3,3,5-trimethylcyclohexane, t-hexyl peroxypivalate, t-butyl peroxypivalate, 2,5-dimethyl-2,5-bis(2-ethylhexanoylperoxy)hexane, t-hexylperoxy-2-ethylhexanoate, t-butylperoxy-2-ethylhexanoate, t-butyl peroxyisobutyrate, t-butyl peroxy-3,5,5-trimethylhexanoate, and t-butyl peroxylaurate.

The azo compound is not limited as long as it is one commonly used in radical polymerization. Examples of the azo compound include 2,2′-azobis(isobutyronitrile), 2,2′-azobis(2-methylbutyronitrile), 2,2′-azobis(2,4-dimethylvaleronitrile), 2,2′-azobis(4-methoxy-2,4-dimethylvaleronitrile), 1,1-azobis(cyclohexane-1-carbonitrile), 1-[(1-cyano-1-methylethyl) azo]formamide, 4,4′-azobis(4-cyanovaleric acid), dimethyl-2,2′-azobis(2-methylpropionate), dimethyl-1,1′-azobis(1-cyclohexanecarboxylate), 2,2′-azobis {2-methyl-N-[1,1′-bis(hydroxymethyl)-2-hydroxyethyl]propionamide}, 2,2′-azobis [2-methyl-N-(2-hydroxyethyl) propionamide], 2,2′-azobis [N-(2-propenyl)-2-methylpropionamide], 2,2′-azobis(N-butyl-2-methylpropionamide), 2,2′-azobis(N-cyclohexyl-2-methylpropionamide), 2,2′-azobis [2-(2-imidazolin-2-yl) propane]dihydrochloride, 2,2′-azobis {2-[1-(2-hydroxyethyl)-2-imidazolin-2-yl]propane}dihydrochloride, 2,2′-azobis [2-(2-imidazolin-2-yl) propane], 2,2′-azobis(2-amidinopropane) dihydrochloride, 2,2′-azobis [N-(2-carboxyethyl)-2-methylpropionamidine]tetrahydrate, 2,2′-azobis(1-imino-1-pyrrolidino-2-methylpropane) dihydrochloride, and 2,2′-azobis(2,4,4-trimethylpentane).

The polymerization initiator, which is a polymerization initiator for initiating living radical polymerization, is not limited, and is preferably an organotellurium polymerization initiator.

Such polymerization initiators may be used singly or in combinations of two or more kinds thereof.

When the monomer mixture is subjected to a radical reaction, a dispersion stabilizer may be used. Examples of the dispersion stabilizer include polyvinyl pyrrolidone, polyvinyl alcohol, methylcellulose, ethylcellulose, poly(meth)acrylic acid, poly(meth)acrylate, and polyethylene glycol.

In a case where a polymerization solvent is used in the radical reaction of the monomer mixture, the polymerization solvent is not limited. The polymerization solvent used here can be, for example, a non-polar solvent such as hexane, cyclohexane, octane, toluene, or xylene. The polymerization solvent used here can also be, for example, a highly polar solvent such as water, methanol, ethanol propanol, acetone, methyl ethyl ketone, methyl isobutyl ketone, tetrahydrofuran, dioxane, or N,N-dimethylformamide. Such polymerization solvents may be used singly or in combinations of two or more kinds thereof.

The rubber adhesive includes a rubber polymer. Examples of the rubber polymer include natural rubber and an A-B-A block copolymer rubber.

Specific examples of the natural rubber include styrene-butadiene rubber, polyisoprene, polybutene (which refers to 1-butene and cis- or trans-2-butene), polyisobutylene, an A-B-A-type block copolymer rubber, and any hydrogenated products thereof.

Specific examples of the A-B-A block copolymer rubber include a styrene-butadiene-styrene block (SBS) copolymer, a styrene-isoprene-styrene block (SIS) copolymer, a styrene-isobutylene-styrene block copolymer rubber, styrene-vinyl·isoprene-styrene block copolymer rubber, styrene-ethylene-butylene-styrene block (SEBS) copolymer rubber, which is hydrogenated SBS, styrene-ethylene-propylene-styrene block (SEPS) copolymer rubber, which is hydrogenated SIS, and a styrene-isoprene-propylene-styrene block copolymer. Such rubber polymers may be used singly or in combinations of two or more kinds thereof.

The rubber polymer preferably has less than 20% by mass of a styrene-derived structural unit. When the rubber polymer has less than 20% by mass of a styrene-derived structural unit, outgassing due to the resulting adhesive tape can be more decreased (in particular, generation of a gas that can deteriorate durability, reliability, or working accuracy of electronic equipment such as a magnetic disk apparatus is inhibited). The rubber polymer more preferably has less than 10% by mass of the styrene-derived structural unit, particularly preferably does not have the styrene-derived structural unit.

The first adhesive layer preferably further contains an inorganic mineral. When the first adhesive layer contains an inorganic mineral, the resulting adhesive tape is more enhanced in barrier ability.

Examples of the inorganic mineral include an inorganic filler and a layered clay mineral.

Specific examples of the inorganic filler include a silica filler.

Specific examples of the layered clay mineral include smectite (for example, hydrophilic smectite such as LUCENTITE SAN316, SAN, STN, and SPN (available from Co-op Chemical Co., Ltd.)), and MICROMICA (for example, MK-300 (available from Katakura & Co-op Agri Corporation)). Such inorganic minerals may be used singly or in combinations of two or more kinds thereof.

The lower limit of the amount of the inorganic mineral based on 100 parts by mass of the adhesive is preferably 10 parts by mass and the upper limit thereof is preferably 200 parts by mass. When the amount of the inorganic mineral is 10 parts by mass or more, the resulting adhesive tape is more enhanced in barrier ability. When the amount of the inorganic mineral is 200 parts by mass or less, the resulting adhesive tape has higher adhesion and is more enhanced in L-shaped bending applicability. The lower limit of the amount of the inorganic mineral is more preferably 30 parts by mass and the upper limit thereof is more preferably 100 parts by mass, and the lower limit is further preferably 40 parts by mass and the upper limit is further preferably 75 parts by mass.

The first adhesive layer preferably further contains a crosslinking agent. When the first adhesive layer contains a crosslinking agent, a crosslinked structure is formed between main chains of a resin (for example, the (meth)acrylic copolymer or a tackifier described below) constituting the first adhesive layer and therefore the first adhesive layer is more enhanced in cohesion. As a result, the resulting adhesive tape has higher adhesion and is more enhanced in L-shaped bending applicability.

Examples of the crosslinking agent include an isocyanate crosslinking agent, an aziridine crosslinking agent, an epoxy crosslinking agent, and a metal chelate crosslinking agent. In particular, an isocyanate crosslinking agent is preferred from the viewpoint that the crosslinked structure can be easily formed.

The lower limit of the amount of the crosslinking agent based on 100 parts by mass of the adhesive is preferably 0.01 parts by mass and the upper limit thereof is preferably 10 parts by mass. When the amount of the crosslinking agent falls within the above range, the resulting adhesive tape is more enhanced in L-shaped bending applicability. The lower limit of the amount of the crosslinking agent is more preferably 0.1 parts by mass and the upper limit thereof is more preferably 3 parts by mass.

The first adhesive layer may further contain a tackifier. When the first adhesive layer contains a tackifier, the resulting adhesive tape has higher adhesion and is more enhanced in L-shaped bending applicability.

Examples of the tackifier include a rosin resin, a rosin ester resin, a hydrogenated rosin resin, a terpene resin, a terpene phenolic resin, a coumarone-indene resin, an alicyclic saturated hydrocarbon resin, a C5 petroleum resin, a C9 petroleum resin, a C5-C9 copolymerized petroleum resin, a hydrogenated C5 petroleum resin, a hydrogenated C9 petroleum resin, and a hydrogenated C5-C9 copolymerized petroleum resin.

In particular, a hydrogenated rosin resin, an alicyclic saturated hydrocarbon resin, a hydrogenated C5 petroleum resin, a hydrogenated C9 petroleum resin, or a hydrogenated C5-C9 copolymerized petroleum resin is preferred from the viewpoints of more reducing the polarity of the adhesive layer, more reducing the water vapor transmission rate at 40° C. and 90% RH, and more enhancing the barrier ability of the resulting adhesive tape.

A rosin resin or a terpene resin is preferred, and a hydroxy group-containing rosin resin or a hydroxy group-containing terpene resin is more preferred, from the viewpoint of adhesion control.

Such tackifiers may be used singly or in combinations of two or more kinds thereof.

The lower limit of the softening temperature of the tackifier is preferably 70° C. and the upper limit thereof is preferably 170° C. When the softening temperature of the tackifier is 70° C. or more, the first adhesive layer is less likely to be excessively soft. When the softening temperature of the tackifier is 170° C. or less, the first adhesive layer can have high wettability to an adherend. The lower limit of the softening temperature of the tackifier is more preferably 120° C. and the upper limit thereof is more preferably 160°.

The softening temperature is the softening temperature measured by JIS K 2207 (ring-and-ball method).

The first adhesive layer may further contain a silane coupling agent for the purpose of an enhancement of the adhesive tape. Examples of the silane coupling agent include epoxysilanes, acrylic silanes, methacrylic silanes, aminosilanes, isocyanate silanes, vinylsilanes, and butadiene polymer-modified silanes.

The upper limit of the water vapor transmission rate at 40° C. and 90% RH of the first adhesive layer is preferably 300 g/(m²·day). When the water vapor transmission rate at 40° C. and 90% RH of the first adhesive layer is 300 g/(m²·day) or less, the resulting adhesive tape is more enhanced in barrier ability. The upper limit of the water vapor transmission rate at 40° C. and 90% RH of the first adhesive layer is more preferably 200 g/(m²·day), further preferably 100 g/(m²·day).

A preferred lower limit of the water vapor transmission rate at 40° C. and 90% RH of the first adhesive layer is not limited, and the lower limit is substantially about 10 g/(m²·day).

The water vapor transmission rate at 40° C. and 90% RH of the first adhesive layer can be measured by laminating the adhesive layer and a 200-mesh metal net to prepare an adhesive layer sample, and subjecting the sample to measurement in the same manner as the above measurement method of the water vapor transmission rate at 40° C. and 90% RH.

The water vapor transmission rate at 40° C. and 90% RH of the first adhesive layer can be adjusted by the type of the adhesive used in the adhesive layer and the density of the adhesive layer. For example, selecting a material having a large polarity difference from the polarity of water vapor, namely, a water molecule, results in lowered moisture permeability. In other words, since a water molecule has high polarity, the moisture permeability is lowered when a material selected is constituted from an atom group with low polarity. In a case where the adhesive is constituted from a high-molecular polymer, the smaller the free volume of the high-molecular polymer, the lower the moisture permeability. In other words, a polymer whose side chains are symmetric is more easily packed and therefore the free volume is smaller and the moisture permeability is lower. Furthermore, a polymer having a crystal structure has a lower moisture permeability. The free volume can also be changed to adjust the moisture permeability by the molecular weight, hydrogen bondability, molecular rigidity, and crosslinking density of a polymer. In addition, when a layered viscous compound or the like inhibiting permeation of a water molecule is added to and dispersed in the adhesive, the compound blocks water molecules, resulting in lowered moisture permeability.

The lower limit of the tensile storage elastic modulus at 25° C. of the first adhesive layer is preferably 0.01 MPa and the upper limit thereof is preferably 5 MPa. When the tensile storage elastic modulus at 25° C. of the first adhesive layer falls within the above range, the product of the tensile storage elastic modulus and the thickness of the first adhesive layer is easily adjusted in the above range and the resulting adhesive tape is more enhanced in L-shaped bending applicability. The lower limit of the tensile storage elastic modulus at 25° C. of the first adhesive layer is more preferably 0.05 MPa and the upper limit thereof is more preferably 1 MPa, and the lower limit is further preferably 0.1 MPa and the upper limit is further preferably 0.5 MPa. The tensile storage elastic modulus at 25° C. of the first adhesive layer can be obtained by the following method.

Specifically, a plurality of such adhesive layers is laminated to produce a 1-mm thick adhesive layer for measurement, and thereafter the shear storage elastic modulus at 25° C. is measured with a dynamic viscoelasticity measurement apparatus (“DVA-200” available from IT Measurement & Control Co., Ltd.) under conditions of a measurement mode of shear, 25° C., a frequency of 1 Hz, a rate of temperature rise of 5° C./min, a temperature range of 0° C. to 100° C., and a set strain of 0.1%. The resulting shear storage elastic modulus at 25° C. is multiplied with 3 to provide a product, and the product is defined as the tensile storage elastic modulus at 25° C.

Examples of the method for adjusting the tensile storage elastic modulus at 25° C. of the first adhesive layer include a method including modifying the compositional ratio of the adhesive contained in the adhesive layer.

The lower limit of the thickness of the first adhesive layer is preferably 10 μm and the upper limit thereof is preferably 200 μm. When the thickness of the first adhesive layer falls within the above range, the resulting adhesive tape has more excellent barrier ability and more excellent L-shaped bending applicability. The lower limit of the thickness of the first adhesive layer is more preferably 15 μm and the upper limit thereof is more preferably 180 μm, and the lower limit is further preferably 18 μm and the upper limit is further preferably 150 μm.

The lower limit of the gel fraction of the first adhesive layer is preferably 1% by mass and the upper limit thereof is preferably 90% by mass. When the gel fraction of the first adhesive layer is 1% by mass or more, the first adhesive layer is more enhanced in cohesion. When the gel fraction of the first adhesive layer is 90% by mass or less, the first adhesive layer is less likely to have an excessively low wettability to an adherend. The lower limit of the gel fraction of the first adhesive layer is more preferably 20% by mass and the upper limit thereof is more preferably 80% by mass, and the lower limit is further preferably 30% by mass and the upper limit is further preferably 70% by mass.

The gel fraction of the first adhesive layer can be here measured by, for example, the following method.

The gel fraction can be determined by cutting the adhesive tape into a plane rectangle of 50 mm×100 mm to produce a test piece, immersing the test piece in ethyl acetate at 23° C. for 24 hours, thereafter taking out the test piece from the ethyl acetate and drying the test piece under a condition of 110° C. for 1 hour, and measuring the mass of the test piece after drying to calculate the gel fraction with the following expression (4). It is noted that a release film for protecting the adhesive layer is not laminated on the test piece.

$$Gel fraction ( \% by mass ) = 100 \times ( {W}_{2} - {W}_{0} ) / ( {W}_{1} - {W}_{0} ) \qquad ( 4 )$$

(W₀: mass of substrate, W₁: mass of test piece before immersion, W₂: mass of test piece after immersion and drying)

The adhesive tape of the present invention may have any other layer as long as the effects of the present invention are not impaired.

The adhesive tape of the present invention preferably has a structure in which a second substrate layer and a second adhesive layer are further laminated on the first adhesive layer of a laminate having the first substrate layer and the first adhesive layer. In other words, the adhesive tape of the present invention preferably has the first substrate layer, the first adhesive layer, the second substrate layer, and the second adhesive layer in the listed order. When the adhesive tape of the present invention has such a structure, barrier ability and L-shaped bending applicability are more enhanced.

The second substrate layer may contain a foam but preferably does not contain a foam from the viewpoint of a more enhancement in barrier ability of the resulting adhesive tape.

Examples of the resin constituting the second substrate layer include an olefinic thermoplastic resin, a thermoplastic elastomer, an acrylic resin, and a polyurethane resin. These may be used singly or in combinations of two or more kinds thereof. Any other resin than these, such as a silicone resin, a vinyl chloride resin, a styrene resin, a polyester resin, a polyamide resin, or an ionomer resin may be used. In particular, at least one resin selected from an olefinic thermoplastic resin and a thermoplastic elastomer is preferably contained from the viewpoint of easy adjustment of the 10% thermal shrinkage temperature described below in an appropriate range, and furthermore an olefinic thermoplastic resin is more preferably contained from the viewpoint of a more enhancement in barrier ability of the resulting adhesive tape. Such resins used in a second substrate layer may be used singly or in combinations of two or more kinds thereof.

The upper limit of the water vapor transmission rate at 40° C. and 90% RH of the second substrate layer is preferably 100 g/(m²·day). When the water vapor transmission rate at 40° C. and 90% RH of the second substrate layer is 100 g/(m²·day) or less, the resulting adhesive tape is more enhanced in barrier ability. The upper limit of the water vapor transmission rate at 40° C. and 90% RH of the second substrate layer is more preferably 50 g/(m²·day), further preferably 30 g/(m²·day).

A preferred lower limit of the water vapor transmission rate at 40° C. and 90% RH of the second substrate layer is not limited, and the lower limit is substantially about 0.1 g/(m²·day).

The upper limit of the 10% thermal shrinkage temperature in at least one direction of the MD or the TD of the second substrate layer is preferably 95° C. When the 10% thermal shrinkage temperature in at least one direction of the MD or the TD of the second substrate layer is 95° C. or less, the resulting adhesive tape can be more suitably used in a method for manufacturing an HDD described below. The upper limit of the 10% thermal shrinkage temperature in at least one direction of the MD or the TD of the second substrate layer is more preferably 75° C., further preferably 65° C., particularly preferably 55° C. The 10% thermal shrinkage temperature in each of the MD and the TD of the second substrate layer is more preferably 95° C. or less.

The lower limit of the 10% thermal shrinkage temperature in at least one direction of the MD or the TD of the second substrate layer is preferably 40° C. When the 10% thermal shrinkage temperature in at least one direction of the MD or the TD of the second substrate layer is 40° C. or more, the adhesive tape can be stored at ordinary temperature. The lower limit of the 10% thermal shrinkage temperature in at least one direction of the MD or the TD of the second substrate layer is more preferably 50° C., further preferably 60° C.

The lower limit of the tensile storage elastic modulus at 25° C. in at least one direction of the MD or the TD of the second substrate layer is preferably 0.1 MPa and the upper limit thereof is preferably 10000 MPa. When the tensile storage elastic modulus at 25° C. in at least one direction of the MD or the TD of the second substrate layer falls within the above range, the product of the average value of the tensile storage elastic moduli in the MD and the TD and the thickness of the second substrate layer is easily adjusted in the above range and the resulting adhesive tape is more enhanced in L-shaped bending applicability. The lower limit of the tensile storage elastic modulus at 25° C. in at least one direction of the MD or the TD of the second substrate layer is more preferably 1 MPa and the upper limit thereof is more preferably 5000 MPa, and the lower limit is further preferably 5 MPa and the upper limit is further preferably 3000 MPa.

The tensile storage elastic modulus at 25° C. of the second substrate layer can be measured by the same method as in the first substrate layer.

The lower limit of the thickness of the second substrate layer is preferably 10 μm, and the upper limit thereof is preferably 2000 μm. When the thickness of the second substrate layer falls within the above range, the resulting adhesive tape has more excellent barrier ability and more excellent L-shaped bending applicability. The lower limit of the thickness of the second substrate layer is more preferably 20 μm and the upper limit thereof is more preferably 1000 μm, and the lower limit is further preferably 25 μm and the upper limit is further preferably 500 μm.

The second adhesive layer used here can be the same as the first adhesive layer.

The adhesive tape of the present invention preferably further has an inorganic layer. When the adhesive tape of the present invention has an inorganic layer, barrier ability is more enhanced.

Examples of the inorganic layer include aluminum, silver, copper, and alumina. In particular, aluminum is preferred from the viewpoints of productivity and cost.

The inorganic layer is preferably laminated on a surface of the second substrate layer, the surface facing the second adhesive layer. Examples of the method for laminating the inorganic layer include vapor deposition and sputtering. In particular, vapor deposition is preferred from the viewpoint of productivity.

Examples of the method for laminating the inorganic layer by vapor deposition include vacuum vapor deposition.

Preferably, the adhesive tape of the present invention has the first substrate layer, the first adhesive layer, the second substrate layer, and the second adhesive layer in the listed order, the first substrate layer contains a foam, the first substrate layer has a water vapor transmission rate at 40° C. and 90% RH of 40 g/(m²·day) or less, the first substrate layer satisfies that a product of an average value of the tensile storage elastic moduli at 25° C. in the MD and the TD and the thickness is 50 MPa·mm or less, and the second substrate layer has a 10% thermal shrinkage temperature in at least one direction of the MD or the TD, of 95° C. or less. The adhesive tape of the present invention, when thus configured, is more enhanced in barrier ability and L-shaped bending applicability and can be more suitably used in a method for manufacturing an HDD described below.

The method for producing the adhesive tape of the present invention is not limited and the adhesive tape can be produced by, for example, the following method.

Specifically, the adhesive tape can be produced by a method including adding and stirring an adhesive such as a (meth)acrylic copolymer or a rubber polymer, if necessary, an inorganic mineral, a crosslinking agent, a tackifier, and/or the like, and a solvent well, to prepare an adhesive solution, coating a release-treated surface of a release film having the release-treated surface, with the prepared adhesive solution, by use of an applicator, drying the resultant at 110° C. for 5 minutes to form a laminated film (a) with the formed first adhesive layer, furthermore stacking the obtained laminated film (a) on a provided first substrate layer so that the first adhesive layer faces the first substrate layer, to produce a laminate having the first substrate layer and the first adhesive layer, peeling the release film of the obtained laminate and applying the resultant to a provided second substrate layer, thereafter integrally stacking and laminating on the second substrate layer a laminated film (b) with a formed second adhesive layer so that the second adhesive layer faces the second substrate layer, in the same manner as in the laminated film (a), and then aging the resultant at 40° C. for 2 days, to provide the adhesive tape.

The upper limit of the 10% thermal shrinkage temperature in at least one direction of the MD or the TD of the adhesive tape of the present invention is preferably 95° C. When the 10% thermal shrinkage temperature in at least one direction of the MD or the TD of the adhesive tape of the present invention is 95° C. or less, the adhesive tape can be more suitably used in a method for manufacturing an HDD described below.

The upper limit of the 10% thermal shrinkage temperature in at least one direction of the MD or the TD of the adhesive tape of the present invention is more preferably 80° C., further preferably 70° C., particularly preferably 60° C. The 10% thermal shrinkage temperature in each of the MD and the TD of the adhesive tape of the present invention is more preferably 95° C. or less.

The lower limit of the 10% thermal shrinkage temperature in at least one direction of the MD or the TD of the adhesive tape of the present invention is preferably 40° C. When the 10% thermal shrinkage temperature of the adhesive tape of the present invention is 40° C. or more, the adhesive tape can be stored at ordinary temperature. The lower limit of the 10% thermal shrinkage temperature of the adhesive tape of the present invention is more preferably 50° C., further preferably 60° C.

The adhesive tape of the present invention can be used in an application, for example, an electronic equipment application. In particular, the adhesive tape is preferably used for a hard disk to be mounted on electronic equipment, and can be specifically used as a sealing material on the circumference of a housing of an HDD under a gas-purged environment.

The electronic equipment is not limited, and examples thereof include a mobile phone, a camera, a display, a game instrument, an electronic organizer, and a personal computer.

The adhesive tape of the present invention is excellent in both barrier ability and L-shaped bending applicability as described above, and therefore is preferably used for temporary fixation of a member to be mounted on electronic equipment, in particular, temporary fixation for keeping a gas-purged environment. In particular, the adhesive tape is more preferably used for temporary fixation of the circumference of a housing filled with a purge gas, and is more specifically, further preferably used for temporary fixation of the circumference of a housing of a hard disk under a gas-purged environment. Herein, the “temporary fixation” means that the adhesive tape fixes the circumference of a housing during conveyance or the like to inhibit the purge gas from being released, thereby keeping a gas-purged environment, and is peeled off when the member is mounted on electronic equipment or the like. When the adhesive tape of the present invention is used on the circumference of a housing of a hard disk, a gas-purged environment can be kept even in a case where any stepped section is present in the housing.

One aspect of the present invention also relates to a method for manufacturing an HDD having a body including a hard disk and a lid, the method including a step of applying the adhesive tape of the present invention to the body and the lid to seal the HDD. The method for manufacturing an HDD of the present invention allows gas seal from the exterior of a housing with the adhesive tape of the present invention, and thus can manufacture an HDD without deterioration of sealability even in the case of manufacturing a high capacity HDD housing many platters.

In the method for manufacturing an HDD of the present invention, a step of attaching the lid to the body is usually performed before the step of applying the adhesive tape of the present invention to the body and the lid to seal an HDD.

Specific examples of the step of sealing an HDD with the adhesive tape include the following step.

Specifically, examples include a step of using an HDD having a body and a lid and attaching the lid of the HDD to the body of the HDD, and then folding and applying the adhesive tape from an outer circumferential edge of the lid of the HDD to the body of the HDD, to bond the body and lid together and seal the outer circumferential edge of the HDD with the adhesive tape. In particular, the step of sealing the HDD with the adhesive tape preferably includes folding and applying the adhesive tape from the lid to the body and then thermally shrinking the adhesive tape. In a case where the adhesive tape of the present invention is used and folded and applied to bond the lid and the body together, and the adhesive tape applied is thermally shrunk, sealability is excellent even in the case of sealing of a housing from the outside of the housing.

The HDD preferably has a structure in which the body includes a body bottom and a body side wall projected upward from the body bottom and the lid is to be attached onto the side wall. When the HDD has such a structure, sealability in the method for manufacturing an HDD of the present invention is more enhanced.

The HDD also preferably has a structure in which the body has a body corner on a surface of the body side wall, the surface being for attachment of the lid, and the lid has a lid corner to contact the body corner. When the HDD has such a structure, the adhesive tape is thermally shrunk as described below at the portion of the adhesive tape where the body corner and the lid corner are bonded to each other, and thus sealability in the method for manufacturing an HDD of the present invention can be more enhanced and the manufacturing quality of an HDD manufactured can be more enhanced.

FIG. 2 illustrates an outline diagram of a preferred embodiment of the lid and FIG. 3 illustrates an outline diagram of a preferred embodiment of the body. In FIG. 3, illustration of a hard disk is omitted.

In the method for manufacturing an HDD of the present invention, the step of sealing the HDD preferably includes a step (I) of folding and applying the adhesive tape from the lid to the body side wall, and a step (II) of thermally shrinking the adhesive tape after the step (I). When the method for manufacturing an HDD of the present invention has the step (I) and the step (II), sealability in the method for manufacturing an HDD of the present invention is enhanced.

In the method for manufacturing an HDD of the present invention, preferably, the body has the body corner, the lid has the lid corner, the step (I) includes folding and applying the adhesive tape to cover at least the body corner and the lid corner and the step (II) includes thermally shrinking a portion of the adhesive tape, the portion being applied from the lid corner to the body corner. When the method for manufacturing an HDD of the present invention is thus performed, sealability is more enhanced and the manufacturing quality of an HDD manufactured is more enhanced.

Examples of the method for folding and applying the adhesive tape from the lid to the body side wall in the step (I) include a method including attaching the lid onto the body side wall, then attaching the adhesive tape so that a portion of the adhesive tape protrudes outside the outer circumferential edge of the upper surface of the lid, and folding the protruding portion, to apply the adhesive tape from the lid to the body side wall.

The step (I) in the method for manufacturing an HDD of the present invention preferably includes attaching the lid onto the body side wall, attaching the adhesive tape to the outer circumferential edge of the upper surface of the lid so that a portion of the adhesive tape is located outside the outer circumferential edge of the upper surface of the lid, pressing a mold against the lid, the mold containing a mold bottom and a mold side wall projected downward from the outer circumferential edge of the mold bottom, so that the upper surface of the lid and the lower surface of the mold bottom face each other, folding the adhesive tape so that a portion of the adhesive tape, the portion being not in contact with the upper surface of the lid, is located between the mold side wall and the body side wall, to apply the adhesive tape to the body side wall, thereby bonding the body and the lid together.

When the method for manufacturing an HDD of the present invention is thus performed, an entire portion of the adhesive tape that is located outside of the outer circumferential edge of the upper surface of the lid is easily folded simultaneously and instantly with the mold and therefore the method for manufacturing an HDD of the present invention is enhanced in simplicity.

FIG. 4 illustrates an outline diagram of a preferred embodiment of the mold. A mold 4 can be pressed against the lid so that an upper surface of the lid of the HDD, to which the adhesive tape is applied, faces a lower surface 42 of a mold bottom of the mold 4, thereby easily folding the entire portion of the adhesive tape that is attached to the lid to be located outside of the outer circumferential edge of the upper surface of the lid. A mold side wall 43 of the mold 4 allows the folded adhesive tape to be easily kept in an L-shape, and thus the HDD is more easily sealed and sealability in the method for manufacturing an HDD of the present invention is more enhanced. The bottom of the mold may have a hollow structure.

FIG. 5 illustrates a cross-sectional diagram schematically illustrating a state in which the mold is used to fold the adhesive tape into an L-shape to apply it from the lid to the body side wall.

When the pressing is performed so that the upper surface of the lid and the lower surface of the mold bottom face each other, the mold is preferably warmed to 35° C. or more and 60° C. or less and then used. In a case when the mold is warmed to 35° C. or more and used, the adhesive tape is easily folded and applied from the viewpoint of an enhancement in wettability of the adhesive layer, and sealability in the method for manufacturing an HDD of the present invention is more enhanced. In a case when the mold is warmed to 60° C. or less and then used, the manufacturing quality of an HDD manufactured is less likely to be impaired. The mold is more preferably warmed to 50° C. or more and 60° C. or less and then used.

Examples of the method for warming the mold include a method including leaving the mold to stand on a hot plate warmed.

In the step (I), preferably, the adhesive tape is in a frame form having a shape corresponding to the outer circumferential edge of the upper surface of the lid and an outer frame of the adhesive tape in the frame form is attached so as to be located outside the outer circumferential edge of the upper surface of the lid. When the adhesive tape is in such a frame form, interference with any component having other function on an HDD surface can be avoided.

Examples of the method for forming the adhesive tape into a frame form include a method including punching the adhesive tape by pressing with a punching blade.

The step (II) is preferably to thermally shrink the adhesive tape by 10% or more in at least one direction of the MD or the TD. When the adhesive tape is thermally shrunk by 10% or more in at least one direction of the MD or the TD, sealability in the method for manufacturing an HDD of the present invention is more enhanced. The adhesive tape is more preferably thermally shrunk by 20% or more, further preferably thermally shrunk by 30% or more in at least one direction of the MD or the TD. The adhesive tape is more preferably thermally shrunk by 10% or more in each of the MD and the TD.

The upper limit of the temperature of the adhesive tape during thermal shrinkage in the step (II) is preferably 95° C., namely, thermal shrinkage is preferably performed at a temperature of the adhesive tape of 95° C. or less. When the temperature of the adhesive tape during thermal shrinkage is 95° C. or less, the quality of an HDD to be manufactured is more enhanced. The upper limit of the temperature of the adhesive tape during thermal shrinkage is more preferably 80° C., further preferably 70° C., particularly preferably 60° C.

One aspect of the present invention also relates to a hard disk drive sealing structure body including a body and a lid, the body and the lid being fixed with an adhesive tape interposed therebetween, the adhesive tape being thermally shrunk. The HDD sealing structure body of the present invention has an HDD fixed from the outside with the thermally shrunk adhesive tape, and therefore the body of the HDD, even when sealed from the outside without use of any gasket, is sufficiently sealed. Therefore, even when the HDD to be manufactured is a high capacity HDD housing an increased number of platters, the manufacturing quality thereof is excellent.

Examples of the HDD sealing structure body of the present invention include a sealing structure body obtained by folding and applying an adhesive tape from the lid of an HDD to the body side wall and then thermally shrinking the adhesive tape, according to the method for manufacturing an HDD of the present invention.

### Advantageous Effects of Invention

The present invention can provide an adhesive tape excellent in barrier ability and L-shaped bending applicability. The present invention can also provide a method for manufacturing a hard disk drive excellent in sealability even in the case of sealing of a housing from the exterior of the housing, by use of the adhesive tape. The present invention can further provide a hard disk drive sealing structure body sufficiently sealed even in the case of sealing of a housing from the exterior of the housing.

### BRIEF DESCRIPTION OF DRAWINGS

FIG. 1 is a schematic diagram of a model used for calculation of bending rigidity.

FIG. 2 is an outline diagram illustrating a preferred embodiment of a lid of an HDD apparatus used in the manufacturing method of the present invention.

FIG. 3 is an outline diagram illustrating a preferred embodiment of a body of an HDD apparatus used in the manufacturing method of the present invention.

FIG. 4 is an outline diagram illustrating a preferred embodiment of a mold used in the manufacturing method of the present invention.

FIG. 5 is a cross-sectional diagram schematically illustrating a state in which a mold is used to fold an adhesive tape into an L-shape and apply it from a lid to a body side wall of an HDD.

FIG. 6 is a schematic diagram illustrating a shape of an adhesive tape used in evaluation of peeling resistance.

FIG. 7 is a schematic diagram illustrating how a lid of an HDD is to be attached to a body side wall thereof in evaluation of peeling resistance.

FIG. 8 is a schematic diagram illustrating a state in which an adhesive tape is attached to an upper surface of a lid attached onto a body side wall of an HDD in evaluation of peeling resistance.

FIG. 9 is a schematic diagram illustrating how a mold is used to fold an adhesive tape into an L-shape and apply it from a lid to a body side wall of an HDD to a in evaluation of peeling resistance.

FIG. 10 is a schematic diagram illustrating a shape of an adhesive tape used in evaluation of housing sealability (corners not heated).

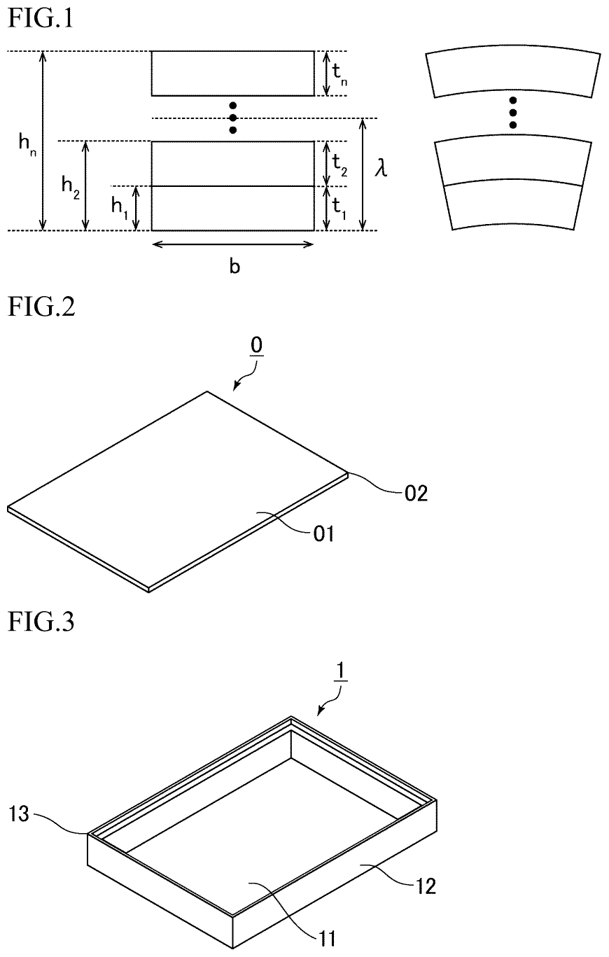

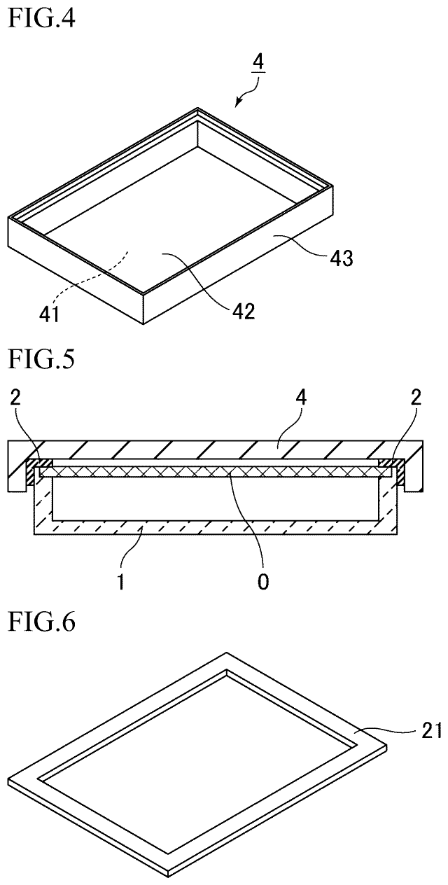

### DESCRIPTION OF EMBODIMENTS

Hereinafter, embodiments of the present invention are described in more detail with reference to examples, but the present invention is not limited to only these examples.

### (Preparation of Acrylic Copolymer-Containing Solution)

After ethyl acetate was added as a polymerization solvent into a reaction container and bubbled with nitrogen, the reaction container was heated with nitrogen flowing to initiate reflux. A polymerization initiator solution obtained by 10-fold dilution of 0.1 parts by mass of azobisisobutyronitrile as a polymerization initiator with ethyl acetate was charged into the reaction container. Thereto were added dropwise 96.9 parts by mass of n-butyl acrylate, 3 parts by mass of acrylic acid, and 0.1 parts by mass of 2-hydroxyethyl acrylate over 2 hours. After completion of dropping, the polymerization initiator solution obtained by 10-fold dilution of 0.1 parts by mass of azobisisobutyronitrile as a polymerization initiator with ethyl acetate was again charged into the reaction container, and a polymerization reaction was performed for 4 hours to obtain an acrylic copolymer-containing solution.

### (Preparation of Adhesive Solution A)

Thirty parts by mass of Super Ester A-125 (available from Arakawa Chemical Industries, Ltd.) as a tackifier based on 100 parts by mass of the acrylic copolymer was added to the resultant acrylic copolymer-containing solution and these were stirred. Furthermore, 2 parts by mass of Takenate D-101E (available from Mitsui Chemicals, Inc.) as a crosslinking agent and ethyl acetate were added thereto and sufficiently stirred to obtain adhesive solution A having a solid content of 30% by mass.

### (Adhesive Solution B)

SK-Dyne 2563PS (rubber adhesive solution, available from Soken Chemical & Engineering Co., Ltd.) was directly used as adhesive solution B.

### (Preparation of Adhesive Solution C)

To adhesive solution A obtained was added 50 parts by mass of MK-300 (Micromica, available from Katakura & Co-op Agri Corporation) as an inorganic mineral based on 100 parts by mass of the acrylic copolymer, and these were stirred to obtain adhesive solution C.

### (Preparation of Adhesive Solution D)

Five parts by mass of Coronate HX (available from Tosoh Corporation) as a crosslinking agent based on 100 parts by mass of the solid content was added to SK-Dyne 2030U (acrylic adhesive solution, available from Soken Chemical & Engineering Co., Ltd.), and these were sufficiently stirred to obtain adhesive solution D.

### (Preparation of Adhesive Solution E)

Adhesive solution E was obtained in the same manner as in “(Preparation of adhesive solution A)” described above except that Super Ester A-125 was not added as a tackifier to the acrylic copolymer solution obtained.

### (Preparation of Adhesive Solution F)

To adhesive solution A obtained was added 50 parts by mass of MAE (Somasif available from Katakura & Co-op Agri Corporation) as an inorganic mineral based on 100 parts by mass of the acrylic copolymer, and these were stirred to obtain adhesive solution F.

### (Preparation of Adhesive Solution G)

To adhesive solution A obtained was added 50 parts by mass of FB-5D (Spherical Silica, available from Denka Co., Ltd.) as an inorganic mineral based on 100 parts by mass of the acrylic copolymer, and these were stirred to obtain adhesive solution G.

### (Preparation of Adhesive Solution H)

To adhesive solution A obtained was added 50 parts by mass of iM30K (hollow silica, Glass Bubbles, available from 3M) as an inorganic mineral based on 100 parts by mass of the acrylic copolymer, and these were stirred to obtain adhesive solution H.

### Example 1

### (Production of Adhesive Tape)

A release-treated surface of a release film having a thickness of 50 μm (“SP3000” available from Toyo Cloth Co., Ltd.) was coated with adhesive solution A obtained, by use of an applicator, and heated and dried (110° C.) to produce a laminated film (a) in which an adhesive layer A having a thickness of 75 μm (0.075 mm) was formed as a first adhesive layer.

The laminated film (a) obtained was laminated on a polyethylene foam (“Volara XL-H #0180015” available from Sekisui Chemical Co., Ltd.), provided as a first substrate layer, to obtain a laminate. The release film of the laminate obtained was removed, a polyester shrink film (“Hishipet PX-40S” available from Mitsubishi Chemical Corporation) provided as a second substrate layer was laminated on the exposed surface of the adhesive layer A of the laminate, and thereafter a laminated film (b) in which an adhesive layer A was formed as a second adhesive layer by the same method as in the laminated film (a) was stacked so that the adhesive layer faced the second substrate layer. Furthermore, the resultant was left to stand at 40° C. for 2 days and aged to obtain an adhesive tape. The lamination was here performed with the MDs of all the layers being aligned. The following measurement and calculation were performed in a state where the release film was removed.

### (Measurement of Tensile Storage Elastic Modulus at 25° C. Of Substrate Layer)

The first substrate layer and the second substrate layer were each subjected to measurement of the tensile storage elastic modulus at 25° C. in each of the MD and the TD with a dynamic viscoelasticity measurement apparatus (“DVA-200” available from IT Measurement & Control Co., Ltd.) under conditions of a measurement mode of tensile, 25° C., a frequency of 1 Hz, a rate of temperature rise of 5° C./min, a temperature range of 0° C. to 100° C., and a set strain of 0.1%. The results were shown in Table 1.

### (Calculation of Tensile Storage Elastic Modulus at 25° C. of Adhesive Layer)

A plurality of the adhesive layers obtained was laminated to produce a 1-mm thick adhesive layer for measurement, and thereafter the shear storage elastic modulus at a temperature of 25° C. was measured with a dynamic viscoelasticity measurement apparatus (“DVA-200” available from IT Measurement & Control Co., Ltd.) under conditions of a measurement mode of shear, 25° C., a frequency of 1 Hz, a rate of temperature rise of 5° C./min, a temperature range of 0° C. to 100° C., and a set strain of 0.1%. The obtained shear storage elastic modulus at a temperature of 25° C. was multiplied with 3 to provide a product, and the product was defined as the tensile storage elastic modulus at 25° C. The respective tensile storage elastic moduli at 25° C. in the MD and the TD were measured, and the results were shown in Table 1.

### (Measurement of Water Vapor Transmission Rate at 40° C. And 90% RH)

The first substrate layer, the first adhesive layer, the second substrate layer, the second adhesive layer, and the adhesive tape obtained were each subjected to measurement of the water vapor transmission rate at 40° C. and 90% RH in the thickness direction with a water vapor transmittance measurement apparatus (“PERMATRAN-W 1/50” available from MOCON Inc.). In the case of the first adhesive layer and the second adhesive layer, each of the adhesive layers was laminated with a 200-mesh metal net to produce a measurement sample. The results were shown in Table 1.

### (Measurement of 10% Thermal Shrinkage Temperature)

The first substrate layer, the second substrate layer, and the adhesive tape obtained were each cut into a plane square of 50 mm width×50 mm length to produce a test piece. The test piece obtained was immersed for 10 seconds in about 1 L of water heated to 50° C. in advance, and then air-cooled to room temperature, the width and the length of the test piece air-cooled were measured, and the width and the length measured were used to provide the thermal shrinkage rate at 50° C. in each of the MD and the TD by the following expression (3). The test piece was similarly immersed for seconds in water at each of 60° C., 70° C., 80° C., 90° C., and 100° C., and air-cooled to room temperature, and thereafter the width and the length thereof were measured and these were used to provide the thermal shrinkage rate at each of 60° C., 70° C., 80° C., 90° C., and 100° C. in each of the MD and the TD by the following expression (3). Based on the obtained thermal shrinkage rate, the 10% thermal shrinkage was determined as follows: a case where the thermal shrinkage rate at 50° C. was more than 10% corresponded to a 10% thermal shrinkage temperature of less than 50° C.; a case where the thermal shrinkage rate at 100° C. was less than 10% corresponded to a 10% thermal shrinkage temperature of more than 100° C.; and in any other cases, the temperature and the thermal shrinkage rate were assumed to be proportional to each other between the maximum temperature at which the thermal shrinkage rate was less than 10% and the minimum temperature at which the thermal shrinkage rate was more than 10%, and the 10% thermal shrinkage temperature was calculated. The 10% thermal shrinkage temperature in each of the MD and the TD was measured, and the results were shown in Table 1.

$$Thermal shrinkage rate ( \% ) = [ ( {L}_{0} - {L}_{1} ) / {L}_{0} ] \times 100 \qquad ( 3 )$$

(L₀: dimension of adhesive tape before immersion in water, L₁: dimension of adhesive tape after immersion in water heated and then air-cooling to room temperature)

### (Calculation of Bending Rigidity of Adhesive Tape)

The bending rigidity in each of the MD and the TD of the adhesive tape obtained was calculated with the expression (1) and the expression (2), as the bending rigidity in a case where the adhesive tape was bent at a bending width of 2.0 mm with an adhesive layer on the outermost surface thereof being located inside. The results were shown in Table 1.

### (Measurement of 180° Peel Force Against SUS at 23° C. Of Adhesive Tape)

The 180° peel force against SUS at 23° C. of the obtained adhesive tape was measured by cutting the resulting adhesive tape into a plane rectangle shape of 25 mm width×150 mm length, pressure-bonding the cut adhesive tape to a SUS304 plate (washed with ethanol and then dry-wiped before use) subjected to surface 2B-finishing prescribed in JIS G 4305, by reciprocating a 2-kg rubber roller twice at a rate of 10 mm/sec a under an environment at 23° C. and 50% RH, furthermore, leaving the resultant to stand under an environment at 23° C. and 50% RH for 20 minutes, and then peeling the adhesive tape from the SUS plate in a 180° peel test performed according to JIS Z 0237, with a tensile tester (“AGS-X” available from Shimadzu Corporation) under conditions of 23° C., 50% RH, and a peeling rate of 300 mm/min. The results were shown in Table 1.

### Examples 2 to 9, 12 to 14, 16 to 29, 37 to 39 and Comparative Examples 1 to 5

Each adhesive tape was produced and subjected to measurement and calculation in the same manner as in Example 1 except that the type of the substrate layer, the type of the adhesive solution, and the thickness of the adhesive layer were those shown in Tables 1 to 6. The results were shown in Tables 1 to 6.

The adhesive layer having a thickness of more than 0.15 mm (second adhesive layer) in each of Examples 37 to 39 was produced by stacking a plurality of adhesive layers, each having a thickness of 0.15 mm after heating and drying, to achieve the thickness shown in Table 5.

### Example 10

Aluminum having a thickness of 45 nm was laminated as an inorganic layer on the second adhesive layer of Hishipet PX-40S provided, by vapor deposition in a vacuum condition, and the resultant was used as the second substrate layer. An adhesive tape was produced and subjected to measurement and calculation in the same manner as in Example 1 except that the type of the substrate layer, the type of the adhesive solution, and the thickness of the adhesive layer were those shown in Table 2. The results were shown in Table 2.

### Example 11 and Comparative Examples 6 and 7

Each adhesive tape was produced and subjected to measurement and calculation in the same manner as in Example 1 except that each adhesive tape was a laminate obtained by laminating the adhesive layer A as the adhesive layer on the first substrate layer shown in Tables 2 and 6. The results were shown in Tables 2 and 6.

### Example 15

In “(Production of adhesive tape)” described above, a laminate which had the first substrate layer, the first adhesive layer, the second substrate layer, and the second adhesive layer shown in Table 2 was produced in the same manner as in Example 1. From the laminate before aging, the release film protecting the second adhesive layer was removed, and a polyester shrink film (available from Mitsubishi Chemical Corporation, “Hishipet LX-21S”) provided as a third substrate layer was laminated on the second adhesive layer so that the TD thereof matched the MD of each of the first and second substrate layers and the MD thereof matched the TD of each of the first and second substrate layers. A laminated film (c) in which an adhesive layer A was formed as a third adhesive layer by the same method as in the laminated film (a) was stacked so that the adhesive layer A faced the third substrate layer, and left to stand at 40° C. for 2 days and aged to obtain an adhesive tape having the first substrate layer, the first adhesive layer, the second substrate layer, the second adhesive layer, the third substrate layer, and the third adhesive layer in the listed order.

Measurement and calculation were performed in the same manner as in Example 1 except that the adhesive tape was thus produced in “(Production of adhesive tape)” described above. The results were shown in Table 2.

### Examples 30 to 35

Each of inorganic layers shown in Tables 4 and 5 was laminated on the second adhesive layer of Hishipet PX-40S (Examples 30 and 33 to 35) or Space clean S2600 (Examples 31 and 32) provided, and the resultant was used as the second substrate layer. Each adhesive tape was produced and subjected to measurement and calculation in the same manner as in Example 1 except that the type of the substrate layer, the type of the adhesive solution, and the thickness of the adhesive layer were those shown in Tables 4 and 5. The results were shown in Tables 4 and 5. Inorganic layers (Al layers (Examples 30 to 32), a Ag layer (Example 33), and a Cu layer (Example 34)) in the respective adhesive tapes of Examples 30 to 34 were formed by vapor deposition under a vacuum condition, and the inorganic layer (Al layer) of the adhesive tape of Example 35 was formed by sputtering under a vacuum condition.

### Example 36

Aluminum having a thickness of 70 nm was laminated as the inorganic layer on the second adhesive layer of Space clean S2600 provided, by vapor deposition under a vacuum condition, and was used as the second substrate layer. In “(Production of adhesive tape)” described above, a laminate which had the first substrate layer, the first adhesive layer, the second substrate layer, and the second adhesive layer shown in Table was produced in the same manner as in Example 1. From the laminate before aging, the release film protecting the second adhesive layer was removed, and Space clean S2600 provided as a third substrate layer was laminated on the second adhesive layer so that the TD thereof matched the MD of each of the first and second substrate layers and the MD thereof matched the TD of each of the first and second substrate layers. A laminated film (c) in which an adhesive layer A was formed as a third adhesive layer by the same method as in the laminated film (a) was stacked so that the adhesive layer A faced the third substrate layer, and left to stand at 40° C. for 2 days and aged to obtain an adhesive tape having the first substrate layer, the first adhesive layer, the second substrate layer, the second adhesive layer, the third substrate layer, and the third adhesive layer in the listed order.

Measurement and calculation were performed in the same manner as in Example 1 except that the adhesive tape was thus produced in “(Production of adhesive tape)” described above. The results were shown in Table 5.

The types of substrates shown in Tables 1 to 6 are shown below.
Volara XL-H #0180015 (polyethylene foam, available from Sekisui Chemical Co., Ltd.)
Volara XL-H #05002 (polyethylene foam, available from Sekisui Chemical Co., Co., Ltd.)
Volara XL-H #018002 (polyethylene foam, available from Sekisui Chemical Ltd.)
Volara XL-H #15004 (polyethylene foam, available from Sekisui Chemical Co., Ltd.)
Volara XL-H #12003 (polyethylene foam, available from Sekisui Chemical Co., Ltd.)
Saran Wrap (registered trademark) (polyvinylidene chloride film, available from Asahi Kasei Home Products Corporation)
Emblem DCDCR-15 (nylon film coated with polyvinylidene chloride, available from Unitika Ltd.)
Emblet DCKPT-12 (polyester film coated with polyvinylidene chloride, available from Unitika Ltd.)
Techbarrier LS (transparent-silica-vapor-deposited high gas barrier film, available from Mitsubishi Chemical Corporation)
BR-PET1012 (aluminum-vapor-deposited polyester film, available from Toray Advanced Film Co., Ltd.)
VM-CPP 2203 (aluminum-vapor-deposited, non-oriented polypropylene film, available from Toray Advanced Film Co., Ltd.)
My Foil (aluminum foil, available from UACJ Foil Corporation)
PE sheet EL (low-density polyethylene film, manufactured Sekisui Seikei Co., Ltd.)
PE sheet EH (high-density polyethylene film, manufactured Sekisui Seikei Co., Ltd.)
Hishipet PX-40S (polyester shrink film, available from Mitsubishi Chemical Corporation)
Krehalon ML40-G (thermally shrinkable multilayer film, available from Kureha Corporation)
FE2002 (polyester film available from Futamura Chemical Co., Ltd.)
Hishipet LX-21S (polyester shrink film, available from Mitsubishi Chemical Corporation)
Krehalon MT500R (polyvinylidene chloride shrink film, available from Kureha Corporation)
Fancywrap FL2 (polyolefin shrink film, available from Gunze Ltd.)
Space clean S7200 (polyester shrink film, available from Toyobo Co., Ltd.)
Space clean S2600 (polyester shrink film, available from Toyobo Co., Ltd.)
Foam layer A (obtained in “(Production of foam layer A)” described below)

### (Production of Foam Layer A)

Into a reaction container were introduced 100 parts by mass of n-butyl acrylate and 11 parts by mass of acrylic acid, to obtain a monomer component. The monomer component was dissolved in ethyl acetate, 0.1 parts by mass of lauroyl peroxide as a polymerization initiator was added at a reflux point, and these were refluxed at 70° C. for hours to obtain a solution of an acrylic polymer having a weight average molecular weight of 720,000. To 100 parts by mass of the acrylic polymer obtained were compounded and mixed 6.3 parts by mass of a rosin ester resin P (softening point 140° C.) as a tackifier, 0.054 parts by mass of M-A5DT (aluminum chelate crosslinking agent available from Soken Chemical & Engineering Co., Ltd.) as a crosslinking agent, and 2.1 parts by mass of Expancel DU120 (thermally expandable microcapsule available from Japan Fillite Co., Ltd.). The resulting mixture was poured into a mold and left to stand at 120° C. for 0.03 hours, to obtain foam layer A having a foaming ratio of 1.5 cm³/g and a thickness of 100 μm.

### <Evaluation>

The adhesive tapes obtained in the examples and the comparative examples were evaluated by the following methods. The results were shown in Tables 1 to 6.

### (Evaluation of Peeling Resistance)

### (1) Production of Housing for Evaluation

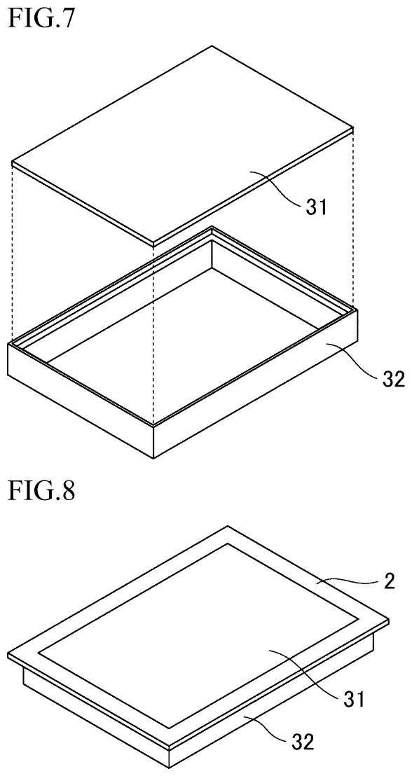

The adhesive tape obtained was cut into a frame form (outer frame 110 mm×150 mm, inner frame 90 mm×130 mm) as illustrated in FIG. 6. A housing made of SUS304 subjected to surface 2B-finishing prescribed in JIS G 4305 was provided, in which the housing had a lid 31 (96×136 mm, thickness 1 mm) and a body 32. The body 32 had a structure in which a body bottom of 100 mm×140 mm has a thickness of 5 mm, and a body side wall has an outer frame of 100 mm×140 mm and an inner frame of 90 mm×130 mm when viewed in a direction opposite to the body bottom, has a height corresponding to a thickness of 22 mm in a direction perpendicular to the body bottom, and has a stepped section (outer frame 97 mm×137 mm, inner frame 90 mm×130 mm) at a position of 2 mm from the uppermost portion of the body. The lid 31 was stacked on and attached to the body 32 with a silicone rubber sheet in a frame form (“silicon rubber sheet” available from AS ONE Corporation, outer frame 94× 134 mm, inner frame 92× 132 mm, thickness 1 mm) interposed therebetween, as illustrated in FIG. 7, and thereafter the adhesive tape 21 cut was applied so as to be perpendicularly pressed against the upper surface of the lid 31 under conditions of 23° C. and 50% RH and so as to allow the four edges of the adhesive tape to protrude by 5 mm from the lid 31 as illustrated in FIG. 8. Thereafter, a mold 5 (outer frame 140 mm×180 mm, inner frame 60 mm×100 mm, thickness 9 mm, a stepped section (outer frame 100.6 mm×140.6 mm, inner frame 60 mm×100 mm) at a position of 6 mm from the uppermost portion of the mold, and a circular cutout having a diameter of 2 mm at each of four corners of the outer frame of the stepped section) heated to 60° C. was pressed against the lid so that the surface of the housing that was covered with the lid 31 was engaged with the mold as illustrated in FIG. 9, and thus the periphery of the adhesive tape 21 protruding from the lid 31 was folded by 5 mm, and applied from the lid 31 to the body side wall of the body 32, to produce a housing for evaluation.

### (2) Determination of Adhesiveness at Edges

The resulting housing for evaluation was left to stand at 23° C. and 50% RH for 3 days, thereafter the adhesiveness at the edges in the bonding portion of the lid 31 and the body 32 was visually determined, and peeling resistance was evaluated. In this evaluation, the adhesiveness at the corners was not considered. A case where the adhesiveness at the edges was kept (no peeling was observed) was rated as “o”. In a case where peeling was observed even only partially on the edges, a housing for evaluation (hereinafter, also referred to as “housing pressure-bonded by hand roller”) was produced as follows: in “(1) Production of housing for evaluation” described above, the periphery of the adhesive tape 21 protruding from the lid 31 was folded by 5 mm to apply the adhesive tape 21 to cover the lid 31 and the body side wall of the body 32, and immediately thereafter the surface of the adhesive tape was pressure-bonded by a hand roller. The adhesiveness at the edges in the obtained housing pressure-bonded by hand roller, after standing at 23° C. and 50% RH for 3 days, were determined in the same manner. A case where the adhesiveness at the edges was kept in the housing pressure-bonded by hand roller was rated as “4”, and a case where peeling was observed even only partially on the edges was rated as “x”

### (Evaluation of Corner Sealability-Onset Temperature)

The temperature of the adhesive tape on a corner of the housing for evaluation after “(Evaluation of peeling resistance)” described above was increased by 5° C. from 50° C. (heating time at each temperature: 10 seconds, highest temperature: 100° C.) with a vinyl chloride welder (warm-air blower) (“NS-300” available from Fuji Impulse Co., Ltd.), and the lowest temperature at which the adhesiveness of the corner was visually confirmed was recorded. The temperature was controlled under temperature measurement with a thermographic camera (“FLIR i60” available from FLIR Systems) by adjusting the output of NS-300 and the distance between the warm-air blowing unit and the adhesive tape. In a case where the rating was “Δ” or “x” in “(Evaluation of peeling resistance)” described above, the housing pressure-bonded by hand roller after “(Evaluation of peeling resistance)” described above was used to perform the present evaluation.

### (Evaluation of Housing Sealability (Corners not Heated))

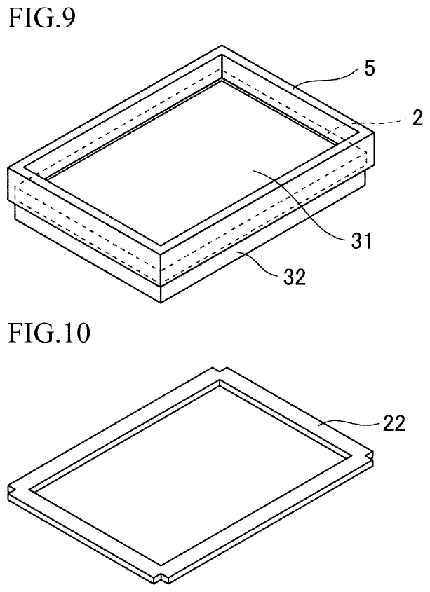

A housing for evaluation was produced in the same manner as in “(Evaluation of peeling resistance)” described above except that a compact temperature and humidity logger (“iButton Hygrochron DS1923-F5 #” available from Maxim Integrated Products) was placed into the housing and the adhesive tape was cut into a shape in FIG. 10 (a square of 5 mm×5 mm was removed from each of four corners of the shape in FIG. 6). The resulting housing for evaluation was left to stand at 40° C. for 1 hour and further left to stand under an environment at 65° C. and 95% RH for 168 hours, and thereafter the humidity in the housing was measured. The housing sealability (corners not heated) was evaluated by rating a case of a humidity in the housing of 60% or less as “o”, and a case of a humidity in the housing of more than 60% as “x”. In a case where the rating was “Δ” or “x” in “(Evaluation of peeling resistance)” described above, the housing pressure-bonded by hand roller was produced in the same manner as in “(Evaluation of peeling resistance)” described above except that a compact temperature and humidity logger (“iButton Hygrochron DS1923-F5 #” available from Maxim Integrated Products) was placed into the housing and the adhesive tape was cut into a shape in FIG. 10 (a square of 5 mm×5 mm was removed from each of four corners of the shape in FIG. 6). The obtained housing pressure-bonded by hand roller was used to perform the present evaluation.

### (Evaluation of Housing Sealability (Corners Heated))

A housing for evaluation was produced in the same manner as in “(Evaluation of peeling resistance)” described above except that the corners of the housing into which a compact temperature and humidity logger (“iButton Hygrochron DS1923-F5 #” available from Maxim Integrated Products) was placed and to which the adhesive tape folded was applied was further heated at any temperature of 75° C., 85° C., or, 95° C. for 10 seconds. The resulting housing for evaluation was left to stand at 40° C. for 1 hour and further left to stand under an environment at 65° C. and 95% RH for 168 hours, and thereafter the humidity in the housing was measured. The housing sealability (corners heated) was evaluated by rating a case where the humidity in the housing with the corners heated at 75° C. was 60% or less as “o”, a case where the humidity in the housing with the corners heated at 85° C. was 60% or less as “o”, a case where the humidity in the housing with the corners heated at 95° C. was 60% or less as “Δ”, and rating a case where the humidity was more than 60% in all the cases as “x”. In a case where rating was “Δ” or “X” in “(Evaluation of peeling resistance)” described above, the housing pressure-bonded by hand roller was produced in the same manner as in “(Evaluation of peeling resistance)” described above except that the corners of the housing into which a compact temperature and humidity logger (“iButton Hygrochron DS1923-F5 #” available from Maxim Integrated Products) was placed and to which the adhesive tape folded was applied was further heated at any temperature of 75° C., 85° C., or, 95° C. for 10 seconds. The obtained housing pressure-bonded by hand roller was used to perform the present evaluation. It is noted that the adhesive tape of the present invention can be used for sealing of an HDD without any problem even in the case of “x” in the present evaluation.

### (Evaluation of Housing Sealability (Corners Heated, Long Period of Time))

The humidity in the housing was measured in the same manner as in “(Evaluation of housing sealability (corners heated))” described above except that adhesive tapes obtained in the same manner as the adhesive tapes rated as “∘∘”, “∘”, and “Δ” in “(Evaluation of housing sealability (corners heated))” described above were used, the heating temperature of the corners of the housing was the temperature at which the humidity in the housing in “(Evaluation of housing sealability (corners heated))” described above was 60% or less, and the standing time under an environment at 65° C. and 95% RH was changed to 336 hours. Herein, [“the temperature at which the humidity in the housing in (Evaluation of housing sealability (corners heated))” described above was 60% or less] refers to 75° C. with respect to “00”, 85° C. with respect to “∘”, or 95° C. with respect to “Δ”, as the evaluation results in “(Evaluation of housing sealability (corners heated))” described above. The housing sealability (corners heated, long period of time) was evaluated by rating a case of a humidity in the housing of 50% or less as “∘∘”, a case of a humidity in the housing of more than 50% and 60% or less as “∘”, and a case of case of a humidity in the housing of more than 60% as “x”. It is noted that the adhesive tape of the present invention can be used for sealing of an HDD without any problem even in the case of “x” in the present evaluation.

TABLE 1

| | | | Example 1 | Example 2 | Example 3 | Example 4 |
|---|---|---|---|---|---|---|
| First | Type | | XL- | XL- | XL- | XL- |
| substrate | | | H#0180015 | H#0180015 | H#0180015 | H#0180015 |
| layer | Thickness (mm) | | 0.15 | 0.15 | 0.15 | 0.15 |
| | Water vapor transmission rate at 40° C. and 90% RH (g/(m² · day)) | | 19 | 19 | 19 | 19 |
| | 10% Thermal | MD | 89 | 89 | 89 | 89 |
| | shrinkage | TD | 82 | 82 | 82 | 82 |
| | temperature (° C.) | | | | | |
| | Tensile storage elastic | MD | 55 | 55 | 55 | 55 |
| | modulus at 25° C. (MPa) | TD | 46 | 46 | 46 | 46 |
| | | Average value | 51 | 51 | 51 | 51 |
| | | of MD and TD | | | | |
| | Average value of tensile storage elastic moduli × Thickness (MPa · mm) | | 7.7 | 7.7 | 7.7 | 7.7 |
| First | Type | | Adhesive | Adhesive | Adhesive | Adhesive |
| adhesive | | | layer A | layer A | layer A | layer A |
| layer | Thickness (mm) | | 0.075 | 0.075 | 0.075 | 0.075 |
| | Water vapor transmission rate at 40° C. and 90% RH (g/(m² · day)) | | 170 | 170 | 170 | 170 |
| | Tensile storage elastic modulus at 25° C. (MPa) | | 0.4 | 0.4 | 0.4 | 0.4 |
| | Tensile storage elastic modulus × Thickness (MPa · mm) | | 0.03 | 0.03 | 0.03 | 0.03 |
| Second | Type | | PX-40S | ML40-G | FE2002 | LX-21S |
| substrate | Inorganic layer | | None | None | None | None |
| layer | Thickness (mm) | | 0.025 | 0.038 | 0.025 | 0.03 |
| | Water vapor transmission rate at 40° C. and 90% RH (g/(m² · day)) | | 23 | 26 | 7.0 | 21 |
| | 10% Thermal | MD | 68 | 63 | more | more |
| | shrinkage | | | | than 100 | than 100 |
| | temperature (° C.) | TD | 66 | 59 | more | 62 |
| | | | | | than 100 | |
| | Tensile storage elastic | MD | 2000 | 420 | 3900 | 2100 |
| | modulus at 25° C. (MPa) | TD | 1200 | 330 | 4000 | 3300 |
| | | Average value | 1600 | 375 | 3950 | 2700 |
| | | of MD and TD | | | | |
| | Average value of tensile storage elastic moduli × Thickness (MPa · mm) | | 40 | 14 | 99 | 81 |
| Second | Type | | Adhesive | Adhesive | Adhesive | Adhesive |
| adhesive | | | layer A | layer A | layer A | layer A |
| layer | Thickness (mm) | | 0.075 | 0.075 | 0.075 | 0.075 |
| | Water vapor transmission rate at 40° C. and 90% RH (g/(m² · day)) | | 170 | 170 | 170 | 170 |
| | Tensile storage elastic modulus at 25° C. (MPa) | | 0.4 | 0.4 | 0.4 | 0.4 |
| | Tensile storage elastic modulus × Thickness (MPa · mm) | | 0.03 | 0.03 | 0.03 | 0.03 |
| Third | Type | | — | — | — | — |
| substrate | Inorganic layer | | — | — | — | — |
| layer | Thickness (mm) | | — | — | — | — |
| | Water vapor transmission rate at 40° C. and 90% RH (g/(m² · day)) | | — | — | — | — |
| | 10% Thermal | MD | — | — | — | — |
| | shrinkage | TD | — | — | — | — |
| | temperature (° C.) | | | | | |
| | Tensile storage elastic | MD | — | — | — | — |
| | modulus at 25° C. (MPa) | TD | — | — | — | — |
| | | Average value | — | — | — | — |
| | | of MD and TD | | | | |
| | Average value of tensile storage elastic moduli × Thickness (MPa · mm) | | — | — | — | — |
| Third | Type | | — | — | — | — |
| adhesive | Thickness (mm) | | — | — | — | — |
| layer | Water vapor transmission rate at 40° C. and 90% RH (g/(m² · day)) | | — | — | — | — |
| | Tensile storage elastic modulus at 25° C. (MPa) | | — | — | — | — |
| | Tensile storage elastic modulus × Thickness (MPa · mm) | | — | — | — | — |
| Adhesive | Thickness (mm) | | 0.325 | 0.338 | 0.325 | 0.33 |
| tape | Water vapor transmission rate at 40° C. and 90% RH (g/(m² · day)) | | 3.5 | 4.4 | 2.0 | 2.9 |
| | 10% Thermal | MD | 79 | 82 | more | 90 |
| | shrinkage | | | | than 100 | |
| | temperature (° C.) | TD | 82 | 78 | more | 81 |
| | | | | | than 100 | |
| | Bending modulus | MD | 0.41 | 0.35 | 0.44 | 0.44 |
| | (N · mm²) | TD | 0.33 | 0.28 | 0.38 | 0.39 |

| | | | | | |
|---|---|---|---|---|---|
| | 180° Peel force against SUS at 23° C. (N/25 mm) | 14.7 | 14.5 | 16.1 | 14.4 |
| Evaluation | Peeling resistance | ∘ | ∘ | ∘ | ∘ |
| | Corner sealability-onset temperature (° C.) | 80 | 75 | more | 90 |
| | | | | than 100 | |
| | Housing sealability (corners not heated) | ∘ | ∘ | ∘ | ∘ |
| | Housing sealability (corners heated) | ∘ | ∘∘ | x | Δ |
| | Housing sealability (corners heated, long period of time) | x | x | — | x |

| | | Example 5 | Example 6 | Example 7 |
|---|---|---|---|---|
| First | Type | XL- | XL- | XL- |
| substrate | | H#0180015 | H#0180015 | H#0180015 |
| layer | Thickness (mm) | 0.15 | 0.15 | 0.15 |
| | Water vapor transmission rate at 40° C. and 90% RH (g/(m² · day)) | 19 | 19 | 19 |

| | | | | |
|---|---|---|---|---|
| 10% Thermal | MD | 89 | 89 | 89 |
| shrinkage | TD | 82 | 82 | 82 |
| temperature (° C.) | | | | |
| Tensile storage elastic | MD | 55 | 55 | 55 |
| modulus at 25° C. (MPa) | TD | 46 | 46 | 46 |
| | Average value | 51 | 51 | 51 |
| | of MD and TD | | | |

| | | | | |
|---|---|---|---|---|
| | Average value of tensile storage elastic moduli × Thickness (MPa · mm) | 7.7 | 7.7 | 7.7 |
| First | Type | Adhesive | Adhesive | Adhesive |
| adhesive | | layer A | layer A | layer A |
| layer | Thickness (mm) | 0.075 | 0.075 | 0.025 |
| | Water vapor transmission rate at 40° C. and 90% RH (g/(m² · day)) | 170 | 170 | 300 |
| | Tensile storage elastic modulus at 25° C. (MPa) | 0.4 | 0.4 | 0.4 |
| | Tensile storage elastic modulus × Thickness (MPa · mm) | 0.03 | 0.03 | 0.01 |
| Second | Type | MT500R | FL2 | PX-40S |
| substrate | Inorganic layer | None | None | None |
| layer | Thickness (mm) | 0.04 | 0.05 | 0.025 |
| | Water vapor transmission rate at 40° C. and 90% RH (g/(m² · day)) | 12 | 2.4 | 23 |

| | | | | |
|---|---|---|---|---|
| 10% Thermal | MD | 95 | 98 | 68 |
| shrinkage | | | | |
| temperature (° C.) | TD | 93 | 71 | 66 |
| Tensile storage elastic | MD | 160 | 1400 | 2000 |
| modulus at 25° C. (MPa) | TD | 120 | 1800 | 1200 |
| | Average value | 140 | 1600 | 1600 |
| | of MD and TD | | | |

| | | | | |
|---|---|---|---|---|
| | Average value of tensile storage elastic moduli × Thickness (MPa · mm) | 5.6 | 80 | 40 |
| Second | Type | Adhesive | Adhesive | Adhesive |
| adhesive | | layer A | layer A | layer A |
| layer | Thickness (mm) | 0.075 | 0.075 | 0.025 |
| | Water vapor transmission rate at 40° C. and 90% RH (g/(m² · day)) | 170 | 170 | 300 |
| | Tensile storage elastic modulus at 25° C. (MPa) | 0.4 | 0.4 | 0.4 |
| | Tensile storage elastic modulus × Thickness (MPa · mm) | 0.03 | 0.03 | 0.01 |
| Third | Type | — | — | — |
| substrate | Inorganic layer | — | — | — |
| layer | Thickness (mm) | — | — | — |
| | Water vapor transmission rate at 40° C. and 90% RH (g/(m² · day)) | — | — | — |

| | | | | |
|---|---|---|---|---|
| 10% Thermal | MD | — | — | — |
| shrinkage | TD | — | — | — |
| temperature (° C.) | | | | |
| Tensile storage elastic | MD | — | — | — |
| modulus at 25° C. (MPa) | TD | — | — | — |
| | Average value | — | — | — |
| | of MD and TD | | | |

| | | | | |
|---|---|---|---|---|
| | Average value of tensile storage elastic moduli × Thickness (MPa · mm) | — | — | — |
| Third | Type | — | — | — |
| adhesive | Thickness (mm) | — | — | — |
| layer | Water vapor transmission rate at 40° C. and 90% RH (g/(m² · day)) | — | — | — |
| | Tensile storage elastic modulus at 25° C. (MPa) | — | — | — |
| | Tensile storage elastic modulus × Thickness (MPa · mm) | — | — | — |
| Adhesive | Thickness (mm) | 0.34 | 0.35 | 0.225 |
| tape | Water vapor transmission rate at 40° C. and 90% RH (g/(m² · day)) | 2.3 | 1.5 | 6.0 |

| | | | | |
|---|---|---|---|---|
| 10% Thermal | MD | 93 | 93 | 79 |
| shrinkage | | | | |
| temperature (° C.) | TD | 91 | 84 | 82 |
| Bending modulus | MD | 0.24 | 0.51 | 0.22 |
| (N · mm²) | TD | 0.19 | 0.46 | 0.17 |

| | | | | |
|---|---|---|---|---|
| | 180° Peel force against SUS at 23° C. (N/25 mm) | 14.4 | 14.1 | 14.9 |
| Evaluation | Peeling resistance | ∘ | ∘ | ∘ |
| | Corner sealability-onset temperature (° C.) | 95 | 95 | 80 |
| | Housing sealability (corners not heated) | ∘ | ∘ | ∘ |
| | Housing sealability (corners heated) | Δ | x | ∘ |
| | Housing sealability (corners heated, long period of time) | x | — | x |

TABLE 2

| | | | Example 8 | Example 9 | Example 10 | Example 11 |
|---|---|---|---|---|---|---|
| First | Type | | XL- | XL- | XL- | XL- |
| substrate | | | H#0180015 | H#0180015 | H#05002 | H#018002 |
| layer | Thickness (mm) | | 0.15 | 0.15 | 0.2 | 0.2 |
| | Water vapor transmission rate at 40° C. and 90% RH (g/(m² · day)) | | 19 | 19 | 29 | 14 |
| | 10% Thermal shrinkage | MD | 89 | 89 | more than 100 | 89 |
| | temperature (° C.) | TD | 82 | 82 | 85 | 82 |
| | Tensile storage elastic modulus | MD | 55 | 55 | 19 | 55 |
| | at 25° C. (MPa) | TD | 46 | 46 | 17 | 46 |
| | | Average value | 51 | 51 | 18 | 51 |
| | | of MD and TD | | | | |
| | Average value of tensile storage elastic moduli × Thickness (MPa · mm) | | 7.7 | 7.7 | 3.6 | 10.2 |
| First | Type | | Adhesive | Adhesive | Adhesive | Adhesive |
| adhesive | | | layer B | layer C | layer A | layer A |
| layer | Thickness (mm) | | 0.075 | 0.075 | 0.075 | 0.075 |
| | Water vapor transmission rate at 40° C. and 90% RH (g/(m² · day)) | | 30 | 75 | 170 | 170 |
| | Tensile storage elastic modulus at 25° C. (MPa) | | 1.7 | 0.5 | 0.4 | 0.4 |
| | Tensile storage elastic modulus × Thickness (MPa · mm) | | 0.10 | 0.04 | 0.03 | 0.03 |
| Second | Type | | PX-40S | PX-40S | PX-40S | — |
| substrate | Inorganic layer | | None | None | Al (45 nm) | — |
| layer | Thickness (mm) | | 0.025 | 0.025 | 0.025 | — |
| | Water vapor transmission rate at 40° C. and 90% RH (g/(m² · day)) | | 23 | 23 | 0.5 | — |
| | 10% Thermal | MD | 68 | 68 | — | — |
| | shrinkage | TD | 66 | 66 | — | — |
| | temperature (° C.) | | | | | |
| | Tensile storage elastic modulus | MD | 2000 | 2000 | — | — |
| | at 25° C. (MPa) | TD | 1200 | 1200 | — | — |
| | | Average value | 1600 | 1600 | — | — |
| | | of MD and TD | | | | |
| | Average value of tensile storage elastic moduli × Thickness (MPa · mm) | | 40 | 40 | 40 | — |
| Second | Type | | Adhesive | Adhesive | Adhesive | — |
| adhesive | | | layer B | layer C | layer A | |
| layer | Thickness (mm) | | 0.075 | 0.075 | 0.075 | — |
| | Water vapor transmission rate at 40° C. and 90% RH (g/(m² · day)) | | 30 | 75 | 170 | — |
| | Tensile storage elastic modulus at 25° C. (MPa) | | 1.7 | 0.5 | 0.4 | — |
| | Tensile storage elastic modulus × Thickness (MPa · mm) | | 0.10 | 0.04 | 0.03 | — |
| Third | Type | | — | — | — | — |
| substrate | Inorganic layer | | — | — | — | — |
| layer | Thickness (mm) | | — | — | — | — |
| | Water vapor transmission rate at 40° C. and 90% RH (g/(m² · day)) | | — | — | — | — |
| | 10% Thermal shrinkage | MD | — | — | — | — |
| | temperature (° C.) | TD | — | — | — | — |
| | Tensile storage elastic modulus | MD | — | — | — | — |
| | at 25° C. (MPa) | TD | — | — | — | — |
| | | Average value | — | — | — | — |
| | | of MD and TD | | | | |
| | Average value of tensile storage elastic moduli × Thickness (MPa · mm) | | — | — | — | — |
| Third | Type | | — | — | — | — |
| adhesive | Thickness (mm) | | — | — | — | — |
| layer | Water vapor transmission rate at 40° C. and 90% RH (g/(m² · day)) | | — | — | — | — |
| | Tensile storage elastic modulus at 25° C. (MPa) | | — | — | — | — |
| | Tensile storage elastic modulus × Thickness (MPa · mm) | | — | — | — | — |
| Adhesive | Thickness (mm) | | 0.325 | 0.325 | 0.375 | 0.275 |
| tape | Water vapor transmission rate at 40° C. and 90% RH (g/(m² · day)) | | 5.2 | 2.2 | 0.5 | 7.4 |
| | 10% Thermal shrinkage | MD | 79 | 79 | 71 | 89 |
| | temperature (° C.) | TD | 82 | 82 | 68 | 82 |
| | Bending | MD | 0.41 | 0.41 | 0.28 | 0.074 |
| | modulus (N · mm²) | TD | 0.33 | 0.33 | 0.24 | 0.062 |

| | | | | | |
|---|---|---|---|---|---|
| | 180° Peel force againstSUS at23° C. (N/25 mm) | 10.1 | 13.0 | 15.6 | 15.3 |
| Evaluation | Peeling resistance | ∘ | ∘ | ∘ | ∘ |
| | Corner sealability-onset temperature (° C.) | 80 | 80 | 70 | 90 |
| | Housing sealability (corners not heated) | ∘ | ∘ | ∘ | ∘ |
| | Housing sealability (corners heated) | ∘ | ∘ | ∘∘ | Δ |
| | Housing sealability (corners heated, long period of time) | x | x | ∘∘ | x |

| | | Example 12 | Example 13 | Example 14 | Example 15 |
|---|---|---|---|---|---|
| First | Type | XL- | XL- | XL- | XL- |
| substrate | | H#018002 | H#15004 | H#0180015 | H#05002 |
| layer | Thickness (mm) | 0.2 | 0.4 | 0.15 | 0.2 |
| | Water vapor transmission rate at 40° C. and 90% RH (g/(m² · day)) | 14 | 35 | 19 | 29 |

| | | | | | |
|---|---|---|---|---|---|
| 10% Thermal shrinkage | MD | 89 | 89 | 89 | more than 100 |
| temperature (° C.) | TD | 82 | 82 | 82 | 85 |
| Tensile storage elastic modulus | MD | 55 | 13 | 55 | 19 |
| at 25° C. (MPa) | TD | 46 | 11 | 46 | 17 |
| | Average value | 51 | 12 | 51 | 18 |
| | of MD and TD | | | | |

| | | | | | |
|---|---|---|---|---|---|
| | Average value of tensile storage elastic moduli × Thickness (MPa · mm) | 10.2 | 4.8 | 7.7 | 3.6 |
| First | Type | Adhesive | Adhesive | Adhesive | Adhesive |
| adhesive | | layer A | layer A | layer A | layer A |
| layer | Thickness (mm) | 0.075 | 0.075 | 0.075 | 0.05 |
| | Water vapor transmission rate at 40° C. and 90% RH (g/(m² · day)) | 170 | 170 | 170 | 200 |
| | Tensile storage elastic modulus at 25° C. (MPa) | 0.4 | 0.4 | 0.4 | 0.4 |
| | Tensile storage elastic modulus × Thickness (MPa · mm) | 0.03 | 0.03 | 0.03 | 0.02 |
| Second | Type | PX-40S | PX-40S | LX-21S | LX21S |
| substrate | Inorganic layer | None | None | None | None |
| layer | Thickness (mm) | 0.025 | 0.025 | 0.055 | 0.03 |
| | Water vapor transmission rate at 40° C. and 90% RH (g/(m² · day)) | 23 | 23 | 15 | 21 |

| | | | | | |
|---|---|---|---|---|---|
| 10% Thermal | MD | 68 | 68 | more | more |
| shrinkage | | | | than 100 | than 100 |
| temperature (° C.) | TD | 66 | 66 | 62 | 62 |
| Tensile storage elastic modulus | MD | 2000 | 2000 | 2100 | 2100 |
| at 25° C. (MPa) | TD | 1200 | 1200 | 3300 | 3300 |
| | Average value | 1600 | 1600 | 2700 | 2700 |
| | of MD and TD | | | | |

| | | | | | |
|---|---|---|---|---|---|
| | Average value of tensile storage elastic moduli × Thickness (MPa · mm)) | 40 | 40 | 149 | 81 |
| Second | Type | Adhesive | Adhesive | Adhesive | Adhesive |
| adhesive | | layer A | layer A | layer A | layer A |
| layer | Thickness (mm) | 0.075 | 0.075 | 0.075 | 0.05 |
| | Water vapor transmission rate at 40° C. and 90% RH (g/(m² · day) | 170 | 170 | 170 | 200 |
| | Tensile storage elastic modulus at 25° C. (MPa) | 0.4 | 0.4 | 0.4 | 0.4 |
| | Tensile storage elastic modulus × Thickness (MPa · mm) | 0.03 | 0.03 | 0.03 | 0.02 |
| Third | Type | — | — | — | LX21S |
| substrate | Inorganic layer | — | — | — | None |
| layer | Thickness (mm) | — | — | — | 0.03 |
| | Water vapor transmission rate at 40° C. and 90% RH (g/(m² · day)) | — | — | — | 21 |

| | | | | | |
|---|---|---|---|---|---|
| 10% Thermal shrinkage | MD | — | — | — | 62 |
| temperature (° C.) | TD | — | — | — | more |
| | | | | | than 100 |
| Tensile storage elastic modulus | MD | — | — | — | 3300 |
| at 25° C. (MPa) | TD | — | — | — | 2100 |
| | Average value | — | — | — | 2700 |
| | of MD and TD | | | | |

| | | | | | |
|---|---|---|---|---|---|
| | Average value of tensile storage elastic moduli × Thickness (MPa · mm) | — | — | — | 81 |
| Third | Type | — | — | — | Adhesive |
| | | | | | layer A |
| adhesive | Thickness (mm) | — | — | — | 0.05 |
| layer | Water vapor transmission rate at 40° C. and 90% RH (g/(m² · day)) | — | — | — | 200 |
| | Tensile storage elastic modulus at 25° C. (MPa) | — | — | — | 0.4 |
| | Tensile storage elastic modulus × Thickness (MPa · mm) | — | — | — | 0.02 |
| Adhesive | Thickness (mm) | 0.375 | 0.575 | 0.355 | 0.41 |
| tape | Water vapor transmission rate at 40° C. and 90% RH (g/(m² · day)) | 3.0 | 6.3 | 2.5 | 5.1 |

| | | | | | |
|---|---|---|---|---|---|
| 10% Thermal shrinkage | MD | 79 | 70 | 92 | 85 |
| temperature (° C.) | TD | 82 | 68 | 77 | 85 |
| Bending | MD | 0.71 | 0.92 | 0.62 | 0.88 |
| modulus (N · mm²) | TD | 0.56 | 0.76 | 0.52 | 0.80 |

| | | | | | |
|---|---|---|---|---|---|
| | 180° Peel force againstSUS at23° C. (N/25 mm) | 16.7 | 15.7 | 15.0 | 18.3 |
| Evaluation | Peeling resistance | ∘ | ∘ | ∘ | ∘ |
| | Corner sealability-onset temperature (° C.) | 80 | 70 | 90 | 85 |
| | Housing sealability (corners not heated) | ∘ | ∘ | ∘ | ∘ |
| | Housing sealability (corners heated) | ∘ | ∘∘ | Δ | ∘ |
| | Housing sealability (corners heated, long period of time) | x | x | x | x |

TABLE 3

| | | | Example 16 | Example 17 | Example 18 | Example 19 |
|---|---|---|---|---|---|---|
| First | Type | | Foam | Saran | DCR-15 | KPT-12 |
| substrate | | | layer A | Wrap | | |
| layer | Thickness (mm) | | 0.1 | 0.011 | 0.015 | 0.012 |
| | Water vapor transmission rate at 40° C. and 90% RH (g/(m² · day)) | | 130 | 12 | 15 | 15 |
| | 10% Thermal | MD | more | more | more | more |
| | shrinkage | | than 100 | than 100 | than 100 | than 100 |
| | temperature | TD | more | more | more | more |
| | (° C.) | | than 100 | than 100 | than 100 | than 100 |
| | Tensile storage elastic modulus | MD | 1.0 | 470 | 1500 | 4000 |
| | at 25° C. (MPa) | TD | 1.0 | 730 | 1000 | 4100 |
| | | Average value | 1 | 600 | 1250 | 4050 |
| | | of MD and TD | | | | |
| | Average value of tensile storage elastic moduli × Thickness | | 0.10 | 6.6 | 19 | 49 |
| | (MPa · mm) | | | | | |
| First | Type | | Adhesive | Adhesive | Adhesive | Adhesive |
| adhesive | | | layer A | layer A | layer A | layer A |
| layer | Thickness (mm) | | 0.075 | 0.075 | 0.075 | 0.075 |
| | Water vapor transmission rate at 40° C. and 90% RH (g/(m² · day)) | | 170 | 170 | 170 | 170 |
| | Tensile storage elastic modulus at 25° C. (MPa) | | 0.4 | 0.4 | 0.4 | 0.4 |
| | Tensile storage elastic modulus × Thickness (MPa · mm) | | 0.03 | 0.03 | 0.03 | 0.00 |
| Second | Type | | PX-40S | PX-40S | PX-40S | PX-40S |
| substrate | Inorganic layer | | None | None | None | None |
| layer | Thickness (mm) | | 0.025 | 0.025 | 0.025 | 0.025 |
| | Water vapor transmission rate at 40° C. and 90% RH (g/(m² · day)) | | 23 | 23 | 23 | 23 |
| | 10% Thermal shrinkage | MD | 68 | 68 | 68 | 68 |
| | temperature (° C.) | TD | 66 | 66 | 66 | 66 |
| | Tensile storage elastic modulus | MD | 2000 | 2000 | 2000 | 2000 |
| | at 25° C. (MPa) | TD | 1200 | 1200 | 1200 | 1200 |
| | | Average value | 1600 | 1600 | 1600 | 1600 |
| | | of MD and TD | | | | |
| | Average value of tensile storage elastic moduli × Thickness | | 40 | 40 | 40 | 40 |
| | (MPa · mm) | | | | | |
| Second | Type | | Adhesive | Adhesive | Adhesive | Adhesive |
| adhesive | | | layer A | layer A | layer A | layer A |
| layer | Thickness (mm) | | 0.075 | 0.075 | 0.075 | 0.075 |
| | Water vapor transmission rate at 40° C. and 90% RH (g/(m² · day)) | | 170 | 170 | 170 | 170 |
| | Tensile storage elastic modulus at 25° C. (MPa) | | 0.4 | 0.4 | 0.4 | 0.4 |
| | Tensile storage elastic modulus × Thickness (MPa · mm) | | 0.03 | 0.03 | 0.03 | 0.00 |
| Third | Type | | — | — | — | — |
| substrate | Inorganic layer | | — | — | — | — |
| layer | Thickness (mm) | | — | — | — | — |
| | Water vapor transmission rate at 40° C. and 90% RH (g/(m² · day)) | | — | — | — | — |
| | 10% Thermal shrinkage | MD | — | — | — | — |
| | temperature (° C.) | TD | — | — | — | — |
| | Tensile storage elastic modulus | MD | — | — | — | — |
| | at 25° C. (MPa) | TD | — | — | — | — |
| | | Average value | — | — | — | — |
| | | of MD and TD | | | | |
| | Average value of tensile storage elastic moduli × Thickness | | — | — | — | — |
| | (MPa · mm) | | — | — | — | — |
| Third | Type | | — | — | — | — |
| adhesive | Thickness (mm) | | — | — | — | — |
| layer | Water vapor transmission rate at 40° C. and 90% RH (g/(m² · day)) | | — | — | — | — |
| | Tensile storage elastic modulus at 25° C. (MPa) | | — | — | — | — |
| | Tensile storage elastic modulus × Thickness (MPa · mm) | | — | — | — | — |
| Adhesive | Thickness (mm) | | 0.275 | 0.186 | 0.19 | 0.187 |
| tape | Water vapor transmission rate at 40° C. and 90% RH (g/(m² · day)) | | 6.9 | 2.8 | 3.1 | 3.1 |
| | 10% Thermal | MD | 70 | 79 | 82 | 85 |
| | shrinkage | TD | 68 | 82 | 85 | 88 |
| | temperature | | | | | |
| | (° C.) | | | | | |
| | Bending modulus | MD | 0.01 | 0.09 | 0.29 | 0.4 |
| | (N · mm³) | TD | 0.01 | 0.1 | 0.18 | 0.33 |
| | 180° Peel force against SUS at 23° C. (N/25 mm) | | 9.6 | 14.0 | 14.1 | 142 |
| Evaluation | Peeling resistance | | ∘ | Δ | Δ | Δ |
| | Corner sealability- onset temperature (° C.) | | 70 | 80 | 90 | 90 |
| | Housing sealability (corners notheated) | | ∘ | ∘ | ∘ | ∘ |
| | Housing sealability (corners heated) | | ∘ | ∘ | Δ | Δ |
| | Housing sealability (corners heated, long period of time) | | x | x | x | x |
| | | | Example 20 | Example 21 | Example 22 | Example 23 |
| First | Type | | LS | 1012 | 2203 | My |
| substrate | | | | | | Foil |
| layer | Thickness (mm) | | 0.012 | 0.012 | 0.02 | 0.012 |
| | Water vapor transmission rate at 40° C. and 90% RH (g/(m² · day)) | | 0.2 | 0.7 | 0.5 | 0.1 |
| | 10% Thermal | MD | more | more | more | more |
| | shrinkage | | than 100 | than 100 | than 100 | than 100 |
| | temperature | TD | more | more | more | more |
| | (° C.) | | than 100 | than 100 | than 100 | than 100 |
| | Tensile storage elastic modulus | MD | 5100 | 4800 | 1100 | 70000 |
| | at 25° C. (MPa) | TD | 4600 | 4700 | 1100 | 70000 |
| | | Average value | 4850 | 4750 | 1100 | 70000 |
| | | of MD and TD | | | | |
| | Average value of tensile storage elastic moduli × Thickness | | 58 | 57 | 22 | 840 |
| | (MPa · mm) | | | | | |
| First | Type | | Adhesive | Adhesive | Adhesive | Adhesive |
| adhesive | | | layer A | layer A | layer A | layer A |
| layer | Thickness (mm) | | 0.075 | 0.075 | 0.075 | 0.075 |
| | Water vapor transmission rate at 40° C. and 90% RH (g/(m² · day)) | | 170 | 170 | 170 | 170 |
| | Tensile storage elastic modulus at 25° C. (MPa) | | 0.4 | 0.4 | 0.4 | 0.4 |
| | Tensile storage elastic modulus × Thickness (MPa · mm) | | 0.03 | 0.03 | 0.03 | 0.03 |
| Second | Type | | PX-40S | PX-40S | PX-40S | PX-40S |
| substrate | Inorganic layer | | None | None | None | None |
| layer | Thickness (mm) | | 0.025 | 0.025 | 0.025 | 0.025 |
| | Water vapor transmission rate at 40° C. and 90% RH (g/(m² · day)) | | 23 | 23 | 23 | 23 |
| | 10% Thermal shrinkage | MD | 68 | 68 | 68 | 68 |
| | temperature (° C.) | TD | 66 | 66 | 66 | 66 |
| | Tensile storage elastic modulus | MD | 2000 | 2000 | 2000 | 2000 |
| | at 25° C. (MPa) | TD | 1200 | 1200 | 1200 | 1200 |
| | | Average value | 1600 | 1600 | 1600 | 1600 |
| | | of MD and TD | | | | |
| | Average value of tensile storage elastic moduli × Thickness | | 40 | 40 | 40 | 4C |
| | (MPa · mm) | | | | | |
| Second | Type | | Adhesive | Adhesive | Adhesive | Adhesive |
| adhesive | | | layer A | layer A | layer A | layer A |
| layer | Thickness (mm) | | 0.075 | 0.075 | 0.075 | 0.075 |
| | Water vapor transmission rate at 40° C. and 90% RH (g/(m² · day)) | | 170 | 170 | 170 | 170 |
| | Tensile storage elastic modulus at 25° C. (MPa) | | 0.4 | 0.4 | 0.4 | 0.4 |
| | Tensile storage elastic modulus × Thickness (MPa · mm) | | 0.03 | 0.03 | 0.03 | 0.03 |
| Third | Type | | — | — | — | — |
| substrate | Inorganic layer | | — | — | — | — |
| layer | Thickness (mm) | | — | — | — | — |
| | Water vapor transmission rate at 40° C. and 90% RH (g/(m² · day)) | | — | — | — | — |
| | 10% Thermal shrinkage | MD | — | — | — | — |
| | temperature (° C.) | TD | — | — | — | — |
| | Tensile storage elastic modulus | MD | — | — | — | — |
| | at 25° C. (MPa) | TD | — | — | — | — |
| | | Average value | — | — | — | — |
| | | of MD and TD | | | | |
| | Average value of tensile storage elastic moduli × Thickness | | — | — | — | — |
| | (MPa · mm) | | — | — | — | — |
| Third | Type | | — | — | — | — |
| adhesive | Thickness (mm) | | — | — | — | — |
| layer | Water vapor transmission rate at 40° C. and 90% RH (g/(m² · day)) | | — | — | — | — |
| | Tensile storage elastic modulus at 25° C. (MPa) | | — | — | — | — |
| | Tensile storage elastic modulus × Thickness (MPa · mm) | | — | — | — | — |
| Adhesive | Thickness (mm) | | 0.187 | 0.187 | 0.195 | 0.187 |
| tape | Water vapor transmission rate at 40° C. and 90% RH (g/(m² · day)) | | 0.1 | 0.4 | 0.3 | 0.1 |
| | 10% Thermal | MD | 87 | 87 | 82 | more |
| | shrinkage | | | | | than 100 |
| | temperature | TD | 90 | 90 | 85 | more |
| | (° C.) | | | | | than 100 |
| | Bending modulus | MD | 0.49 | 0.48 | 0.30 | 0.85 |
| | (N · mm³) | TD | 0.35 | 0.35 | 0.25 | 0.53 |

| | | | | | |
|---|---|---|---|---|---|
| | 180° Peel force against SUS at 23° C. (N/25 mm) | 14.2 | 14.2 | 14.1 | 18.1 |
| Evaluation | Peeling resistance | Δ | Δ | Δ | Δ |
| | Corner sealability- onset temperature (° C.) | 90 | 90 | 90 | more |
| | | | | | than 100 |
| | Housing sealability (corners notheated) | ∘ | ∘ | ∘ | ∘ |
| | Housing sealability (corners heated) | Δ | Δ | Δ | x |
| | Housing sealability (corners heated, long period of time) | Δ | Δ | Δ | — |

TABLE 4

| | | | Example 24 | Example 25 | Example 26 | Example 27 |
|---|---|---|---|---|---|---|
| First | Type | | XL- | XL- | XL- | XL- |
| substrate | | | H#0180015 | H#0180015 | H#0180015 | H#0180015 |
| layer | Thickness (mm) | | 0.15 | 0.15 | 0.15 | 0.15 |
| | Water vapor transmission rate at 40° C. and 90% RH (g/(m² · day)) | | 19 | 19 | 19 | 19 |
| | 10% Thermal | MD | 89 | 89 | 89 | 89 |
| | shrinkage | TD | 82 | 82 | 82 | 82 |
| | temperature (° C.) | | | | | |
| | | MD | 55 | 55 | 55 | 55 |
| | Tensile storage elastic modulus | TD | 46 | 46 | 46 | 46 |
| | at 25° C. (MPa) | Average value | 51 | 51 | 51 | 51 |
| | | of MD and TD | | | | |
| | Average value of tensile storage elastic moduli × Thickness (MPa · mm)) | | 7.7 | 7.7 | 7.7 | 7.7 |
| First | Type | | Adhesive | Adhesive | Adhesive | Adhesive |
| adhesive | | | layer E | layer F | layer G | layer H |
| layer | Thickness (mm) | | 0.075 | 0.075 | 0.075 | 0.075 |
| | Water vapor transmission rate at 40° C. and 90% RH (g/(m² · day)) | | 150 | 150 | 160 | 120 |
| | Tensile storage elastic modulus at 25° C. (MPa) | | 0.4 | 0.4 | 0.4 | 0.4 |
| | Tensile storage elastic modulus × Thickness (MPa · mm) | | 0.03 | 0.03 | 0.03 | 0.03 |
| Second | Type | | PX-40S | PX-40S | PX-40S | PX-40S |
| substrate | Inorganic layer | | None | None | None | None |
| layer | Thickness (mm) | | 0.025 | 0.025 | 0.025 | 0.025 |
| | Water vapor transmission rate at 40° C. and 90% RH (g/(m² · day)) | | 23 | 23 | 23 | 23 |
| | 10% Thermal shrinkage | MD | 68 | 68 | 68 | 68 |
| | temperature (° C.) | TD | 66 | 66 | 66 | 66 |
| | Tensile storage elastic modulus | MD | 2000 | 2000 | 2000 | 2000 |
| | at 25° C. (MPa) | TD | 1200 | 1200 | 1200 | 1200 |
| | | Average value | 1600 | 1600 | 1600 | 1600 |
| | | of MD and TD | | | | |
| | Average value of tensile storage elastic moduli × Thickness (MPa · mm) | | 40 | 40 | 40 | 40 |
| Second | Type | | Adhesive | Adhesive | Adhesive | Adhesive |
| adhesive | | | layer E | layer F | layer H | layer |
| layer | Thickness (mm) | | 0.075 | 0.075 | 0.075 | 0.075 |
| | Water vapor transmission rate at 40° C. and 90% RH (g/(m² · day)) | | 150 | 150 | 160 | 120 |
| | Tensile storage elastic modulus at 25° C. (MPa) | | 0.4 | 0.4 | 0.4 | 0.4 |
| | Tensile storage elastic modulus × Thickness (MPa · mm) | | 0.03 | 0.03 | 0.03 | 0.03 |
| Third | Type | | — | — | — | — |
| substrate | Inorganic layer | | — | — | — | — |
| layer | Thickness (mm) | | — | — | — | — |
| | Water vapor transmission rate at 40° C. and 90% RH (g/(m² · day)) | | — | — | — | — |
| | 10% Thermal shrinkage | MD | — | — | — | — |
| | temperature (° C.) | TD | — | — | — | — |
| | Tensile storage elastic modulus | MD | — | — | — | — |
| | at 25° C. (MPa) | TD | — | — | — | — |
| | | Average value | — | — | — | — |
| | | of MD and TD | | | | |
| | Average value of tensile storage elastic moduli × Thickness (MPa · mm) | | — | — | — | — |
| Third | Type | | — | — | — | — |
| adhesive | Thickness (mm) | | — | — | — | — |
| layer | Water vapor transmission rate at 40° C. and 90% RH (g/(m² · day)) | | — | — | — | — |
| | Tensile storage elastic modulus at 25° C. (MPa) | | — | — | — | — |
| | Tensile storage elastic modulus × Thickness (MPa · mm) | | — | — | — | — |
| Adhesive | Thickness (mm) | | 0.325 | 0.325 | 0.325 | 0.325 |
| tape | Water vapor transmission rate at 40° C. and 90% RH (g/(m² · day))) | | 3.3 | 3.3 | 3.4 | 3.0 |
| | 10% Thermal shrinkage | MD | 79 | 79 | 79 | 79 |
| | temperature (° C.) | TD | 82 | 82 | 82 | 82 |
| | Bending modulus | MD | 0.41 | 0.41 | 0.41 | 0.41 |
| | (N · mm²) | TD | 0.33 | 0.33 | 0.33 | 0.33 |

| | | | | | |
|---|---|---|---|---|---|
| | 180° Peel force against SUS at 23° C. (N/25 mm) | 8.7 | 9.1 | 12.4 | 18.0 |
| Evaluation | Peeling resistance | ∘ | ∘ | ∘ | ∘ |
| | Corner sealability-onset temperature (° C.) | 80 | 80 | 80 | 80 |
| | Housing sealability (corners not heated) | ∘ | ∘ | ∘ | ∘ |
| | Housing sealability (corners heated) | ∘ | ∘ | ∘ | ∘ |
| | Housing sealability (corners heated, long period of time) | x | x | x | x |

| | | Example 28 | Example 29 | Example 30 |
|---|---|---|---|---|
| First | Type | XL- | XL- | XL- |
| substrate | | H#0180015 | H#0180015 | H#05002 |
| layer | Thickness (mm) | 0.15 | 0.15 | 0.2 |
| | Water vapor transmission rate at 40° C. and 90% RH (g/(m² · day)) | 19 | 19 | 29 |

| | | | | |
|---|---|---|---|---|
| 10% Thermal | MD | 89 | 89 | more |
| shrinkage | | | | than 100 |
| temperature (° C.) | TD | 82 | 82 | 85 |
| | MD | 55 | 55 | 19 |
| Tensile storage elastic modulus | TD | 46 | 46 | 17 |
| at 25° C. (MPa) | Average value | 51 | 51 | 18 |
| | of MD and TD | | | |

| | | | | |
|---|---|---|---|---|
| | Average value of tensile storage elastic moduli × Thickness (MPa · mm) | 7.7 | 7.7 | 3.6 |
| First | Type | Adhesive | Adhesive | Adhesive |
| adhesive | | layer A | layer A | layer A |
| layer | Thickness (mm) | 0.075 | 0.075 | 0.075 |
| | Water vapor transmission rate at 40° C. and 90% RH (g/(m² · day)) | 170 | 170 | 170 |
| | Tensile storage elastic modulus at 25° C. (MPa) | 0.4 | 0.4 | 0.4 |
| | Tensile storage elastic modulus × Thickness (MPa · mm) | 0.03 | 0.03 | 0.03 |
| Second | Type | S7200 | S2600 | PX-40S |
| substrate | Inorganic layer | None | None | Al(70 nm) |
| layer | Thickness (mm) | 0.025 | 0.025 | 0.025 |
| | Water vapor transmission rate at 40° C. and 90% RH (g/(m² · day)) | 20 | 20 | 0.4 |

| | | | | |
|---|---|---|---|---|
| 10% Thermal shrinkage | MD | 70 | 70 | 68 |
| temperature (° C.) | TD | 70 | 70 | 66 |
| Tensile storage elastic modulus | MD | 270 | 270 | 2000 |
| at 25° C. (MPa) | TD | 410 | 410 | 1200 |
| | Average value | 340 | 340 | 1600 |
| | of MD and TD | | | |

| | | | | |
|---|---|---|---|---|
| | Average value of tensile storage elastic moduli × Thickness (MPa · mm) | 8.5 | 8.5 | 40 |
| Second | Type | Adhesive | Adhesive | Adhesive |
| adhesive | | layer A | layer A | layer A |
| layer | Thickness (mm) | 0.075 | 0.075 | 0.075 |
| | Water vapor transmission rate at 40° C. and 90% RH (g/(m² · day)) | 170 | 170 | 170 |
| | Tensile storage elastic modulus at 25° C. (MPa) | 0.4 | 0.4 | 0.4 |
| | Tensile storage elastic modulus × Thickness (MPa · mm) | 0.03 | 0.03 | 0.03 |
| Third | Type | — | — | — |
| substrate | Inorganic layer | — | — | — |
| layer | Thickness (mm) | — | — | — |
| | Water vapor transmission rate at 40° C. and 90% RH (g/(m² · day)) | — | — | — |

| | | | | |
|---|---|---|---|---|
| 10% Thermal shrinkage | MD | — | — | — |
| temperature (° C.) | TD | — | — | — |
| Tensile storage elastic modulus | MD | — | — | — |
| at 25° C. (MPa) | TD | — | — | — |
| | Average value | — | — | — |
| | of MD and TD | | | |

| | | | | |
|---|---|---|---|---|
| | Average value of tensile storage elastic moduli × Thickness (MPa · mm) | — | — | — |
| Third | Type | — | — | — |
| adhesive | Thickness (mm) | — | — | — |
| layer | Water vapor transmission rate at 40° C. and 90% RH (g/(m² · day)) | — | — | — |
| | Tensile storage elastic modulus at 25° C. (MPa) | — | — | — |
| | Tensile storage elastic modulus × Thickness (MPa · mm) | — | — | — |
| Adhesive | Thickness (mm) | 0.325 | 0.325 | 0.375 |
| tape | Water vapor transmission rate at 40° C. and 90% RH (g/(m² · day)) | 2.9 | 2.8 | 0.4 |

| | | | | |
|---|---|---|---|---|
| 10% Thermal shrinkage | MD | 84 | 84 | 71 |
| temperature (° C.) | TD | 86 | 86 | 68 |
| Bending modulus | MD | 0.23 | 0.23 | 0.28 |
| (N · mm²) | TD | 0.25 | 0.25 | 0.24 |

| | | | | |
|---|---|---|---|---|
| | 180° Peel force against SUS at 23° C. (N/25 mm) | 14.1 | 14.7 | 15.6 |
| Evaluation | Peeling resistance | ∘ | ∘ | ∘ |
| | Corner sealability-onset temperature (° C.) | 90 | 90 | 70 |
| | Housing sealability (corners not heated) | ∘ | ∘ | ∘ |
| | Housing sealability (corners heated) | Δ | Δ | ∘∘ |
| | Housing sealability (corners heated, long period of time) | x | x | ∘∘ |

TABLE 5

| | | | Example | Example | Example | Example | Example |
|---|---|---|---|---|---|---|---|
| | | | 31 | 32 | 33 | 34 | 35 |
| First | Type | | XL- | XL- | XL- | XL- | XL- |
| substrate | | | H#05002 | H#05002 | H#05002 | H#05002 | H#05002 |
| layer | Thickness (mm) | | 0.2 | 0.2 | 0.2 | 0.2 | 0.2 |
| | Water vapor transmission rate at 40° C. and 90% RH (g/(m² · day)) | | 29 | 29 | 29 | 29 | 29 |
| | 10% Thermal | MD | more | more | more | more | more |
| | shrinkage | | than 100 | than 100 | than 100 | than 100 | than 100 |
| | temperature | TD | 85 | 85 | 85 | 85 | 85 |
| | (° C.) | | | | | | |
| | Tensile storage | MD | 19 | 19 | 19 | 19 | 19 |
| | elastic modulus | TD | 17 | 17 | 17 | 17 | 17 |
| | at 25° C. (MPa) | Average value | 18 | 18 | 18 | 18 | 18 |
| | | of MD and TD | | | | | |
| | Average value of tensile storage elastic moduli × Thickness | | 3.6 | 3.6 | 3.6 | 3.6 | 3.6 |
| | (MPa · mm) | | | | | | |
| First | Type | | Adhesive | Adhesive | Adhesive | Adhesive | Adhesive |
| adhesive | | | layer A | layer A | layer A | layer A | layer A |
| layer | Thickness (mm) | | 0.075 | 0.075 | 0.075 | 0.075 | 0.075 |
| | Water vapor transmission rate at 40° C. and 90% RH (g/(m² · day)) | | 170 | 170 | 170 | 170 | 170 |
| | Tensile storage elastic modulus at25° C. (MPa) | | 0.4 | 0.4 | 0.4 | 0.4 | 0.4 |
| | Tensile storage elastic modulus × Thickness (MPa · mm) | | 0.03 | 0.03 | 0.03 | 0.03 | 0.03 |
| Second | Type | | S2600 | S2600 | PX-40S | PX-40S | PX-40S |
| substrate | Inorganic | | Al(45 nm) | Al(70 nm) | Ag(45 nm) | Cu(45 nm) | Al(45 |
| layer | layer | | | | | | nm |
| | | | | | | | sputtering) |
| | Thickness (mm) | | 0.025 | 0.025 | 0.025 | 0.025 | 0.025 |
| | Water vapor transmission rate at 40° C. and 90% RH (g/(m² · day)) | | 1.6 | 1.4 | 0.4 | 0.3 | 0.1 |
| | 10% Thermal | MD | 70 | 70 | 68 | 68 | 68 |
| | shrinkage | TD | 70 | 70 | 66 | 66 | 66 |
| | temperature | | | | | | |
| | (° C.) | | | | | | |
| | Tensile storage | MD | 270 | 270 | 2000 | 2000 | 2000 |
| | elastic modulus | TD | 410 | 410 | 1200 | 1200 | 1200 |
| | at25° C. (MPa) | | | | | | |
| | | Average value | 340 | 340 | 1600 | 1600 | 1600 |
| | | of MD and TD | | | | | |
| | Average value of tensile storage elastic moduli × Thickness | | 8.5 | 8.5 | 40 | 40 | 40 |
| | (MPa · mm) | | | | | | |
| Second | Type | | Adhesive | Adhesive | Adhesive | Adhesive | Adhesive |
| adhesive | | | layer A | layer A | layer A | layer A | layer A |
| layer | Thickness (mm) | | 0.075 | 0.075 | 0.075 | 0.075 | 0.075 |
| | Water vapor transmission rate at 40° C. and 90% RH (g/(m² · day)) | | 170 | 170 | 170 | 17C | 170 |
| | Tensile storage elastic modulus at25° C. (MPa) | | 0.4 | 0.4 | 0.4 | 0.4 | 0.4 |
| | Tensile storage elastic modulus × Thickness (MPa · mm) | | 0.03 | 0.03 | 0.03 | 0.03 | 0.03 |
| Third | Type | | — | — | — | — | — |
| substrate | Inorganic layer | | — | — | — | — | — |
| layer | Thickness (mm) | | — | — | — | — | — |
| | Water vapor transmission rate at 40° C. and 90% RH (g/(m² · day)) | | — | — | — | — | — |
| | 10% Thermal | MD | — | — | — | — | — |
| | shrinkage | TD | — | — | — | — | — |
| | temperature | | | | | | |
| | (° C.) | | | | | | |
| | Tensile storage | MD | — | — | — | — | — |
| | elastic modulus | TD | — | — | — | — | — |
| | at25° C. (MPa) | | | | | | |
| | | Average value | — | — | — | — | — |
| | | of MD and TD | | | | | |
| | Average value of tensile storage elastic moduli × Thickness | | — | — | — | — | — |
| | (MPa · mm) | | | | | | |
| Third | Type | | — | — | — | — | — |
| adhesive | Thickness (mm) | | — | — | — | — | — |
| layer | Water vapor transmission rate at 40° C. and 90% RH (g/(m² · day)) | | — | — | — | — | — |
| | Tensile storage elastic modulus at25° C. (MPa) | | — | — | — | — | — |
| | Tensile storage elastic modulus × Thickness (MPa · mm) | | — | — | — | — | — |
| Adhesive | Thickness (mm) | | 0.375 | 0.375 | 0.375 | 0.375 | 0.375 |
| tape | Water vapor transmission rate at 40° C. and 90% RH (g/(m² · day)) | | 1.6 | 1.4 | 0.4 | 0.3 | 0.1 |
| | 10% Thermal | MD | 73 | 73 | 71 | 71 | 71 |
| | shrinkage | TD | 73 | 73 | 68 | 68 | 68 |
| | temperature | | | | | | |
| | (° C.) | | | | | | |
| | Bending modulus | MD | 0.20 | 0.20 | 0.28 | 0.28 | 0.28 |
| | (N · mm²) | TD | 0.20 | 0.20 | 0.24 | 0.24 | 0.24 |

| | | | | | | |
|---|---|---|---|---|---|---|
| | 180° Peel force against SUS at23° C. (N/25 mm) | 15.6 | 15.6 | 15.6 | 15.6 | 15.6 |
| Evaluation | Peeling resistance | ∘ | ∘ | ∘ | ∘ | ∘ |
| | Corner sealability-onset temperature (° C.) | 80 | 80 | 70 | 70 | 70 |
| | Housing sealability (corners not heated) | ∘ | ∘ | ∘ | ∘ | ∘ |
| | Housing sealability (corners heated) | ∘∘ | ∘∘ | ∘∘ | ∘ | ∘ |
| | Housing sealability (corners heated, long period of time) | ∘ | ∘ | ∘∘ | ∘∘ | ∘∘ |

| | | Example 36 | Example 37 | Example 38 | Example 39 |
|---|---|---|---|---|---|
| First | Type | XL- | XL- | XL- | XL- |
| substrate | | H#05002 | H#12003 | H#12003 | H#12003 |
| layer | Thickness (mm) | 0.2 | 0.3 | 0.3 | 0.3 |
| | Water vapor transmission rate at 40° C. and 90% RH (g/(m² · day)) | 29 | 46 | 46 | 46 |

| | | | | | |
|---|---|---|---|---|---|
| 10% Thermal | MD | more | 95 | 95 | 95 |
| shrinkage | | than 100 | | | |
| temperature | TD | 85 | 85 | 85 | 85 |
| (° C.) | | | | | |
| Tensile storage | MD | 19 | 4.8 | 4.8 | 4.8 |
| elastic modulus | | | | | |
| at 25° C. (MPa) | TD | 17 | 3.2 | 3.2 | 3.2 |
| | Average value | 18 | 4.0 | 4.0 | 4.0 |
| | of MD and TD | | | | |

| | | | | | |
|---|---|---|---|---|---|
| | Average value of tensile storage elastic moduli × Thickness | 3.6 | 1.2 | 1.2 | 1.2 |
| | (MPa · mm) | | | | |
| First | Type | Adhesive | Adhesive | Adhesive | Adhesive |
| adhesive | | layer A | layer A | layer A | layer A |
| layer | Thickness (mm) | 0.025 | 0.15 | 0.15 | 0.15 |
| | Water vapor transmission rate at 40° C. and 90% RH (g/(m² · day)) | 60 | 85 | 85 | 85 |
| | Tensile storage elastic modulus at25° C. (MPa) | 0.4 | 0.4 | 0.4 | 0.4 |
| | Tensile storage elastic modulus × Thickness (MPa · mm) | 0.01 | 0.06 | 0.06 | 0.06 |
| Second | Type | S2600 | S7200 | S7200 | S7200 |
| substrate | Inorganic | Al (70 nm) | None | None | None |
| layer | layer | | | | |
| | Thickness (mm) | 0.025 | 0.025 | 0.025 | 0.025 |
| | Water vapor transmission rate at 40° C. and 90% RH (g/(m² · day)) | 1.4 | 20 | 20 | 20 |

| | | | | | |
|---|---|---|---|---|---|
| 10% Thermal | MD | 70 | 70 | 70 | 70 |
| shrinkage | TD | 70 | 70 | 70 | 70 |
| temperature | | | | | |
| (° C.) | | | | | |
| Tensile storage | MD | 270 | 270 | 270 | 270 |
| elastic modulus | TD | 410 | 410 | 410 | 410 |
| at25° C. (MPa) | Average value | 340 | 340 | 340 | 340 |
| | of MD and TD | | | | |

| | | | | | |
|---|---|---|---|---|---|
| | Average value of tensile storage elastic moduli × Thickness | 8.5 | 8.5 | 8.5 | 8.5 |
| | (MPa · mm) | | | | |
| Second | Type | Adhesive | Adhesive | Adhesive | Adhesive |
| adhesive | | layer A | layer A | layer A | layer A |
| layer | Thickness (mm) | 0.025 | 0.3 | 0.9 | 1.35 |
| | Water vapor transmission rate at 40° C. and 90% RH (g/(m² · day)) | 60 | 43 | 14 | 9.4 |
| | Tensile storage elastic modulus at25° C. (MPa) | 0.4 | 0.4 | 0.4 | 0.4 |
| | Tensile storage elastic modulus × Thickness (MPa · mm) | 0.01 | 0.12 | 0.36 | 0.54 |
| Third | Type | S2600 | — | — | — |
| substrate | Inorganic layer | Al(70 nm) | — | — | — |
| layer | Thickness (mm) | 0.025 | — | — | — |
| | Water vapor transmission rate at 40° C. and 90% RH (g/(m² · day)) | 1.4 | — | — | — |

| | | | | | |
|---|---|---|---|---|---|
| 10% Thermal | MD | 70 | — | — | — |
| shrinkage | TD | 70 | — | — | — |
| temperature | | | | | |
| (° C.) | | | | | |
| Tensile storage | MD | 270 | — | — | — |
| elastic modulus | TD | 410 | — | — | — |
| at25° C. (MPa) | Average value | 340 | — | — | — |
| | of MD and TD | | | | |

| | | | | | |
|---|---|---|---|---|---|
| | Average value of tensile storage elastic moduli × Thickness | 8.5 | — | — | — |
| | (MPa · mm) | | | | |
| Third | Type | Adhesive | — | — | — |
| | | layer A | | | |
| adhesive | Thickness (mm) | 0.025 | — | — | — |
| layer | Water vapor transmission rate at 40° C. and 90% RH (g/(m² · day)) | 60 | — | — | — |
| | Tensile storage elastic modulus at25° C. (MPa) | 0.4 | — | — | — |
| | Tensile storage elastic modulus × Thickness (MPa · mm) | 0.01 | — | — | — |
| Adhesive | Thickness (mm) | 0.325 | 0.775 | 1.375 | 1.825 |
| tape | Water vapor transmission rate at 40° C. and 90% RH (g/(m² · day)) | 0.1 | 1.5 | 1.5 | 1.5 |

| | | | | | |
|---|---|---|---|---|---|
| 10% Thermal | MD | 72 | 72 | 77 | 82 |
| shrinkage | TD | 72 | 72 | 77 | 82 |
| temperature | | | | | |
| (° C.) | | | | | |
| Bending modulus | MD | 0.20 | 0.26 | 0.48 | 0.97 |
| (N · mm²) | TD | 0.20 | 0.20 | 0.40 | 0.88 |

| | | | | | |
|---|---|---|---|---|---|
| | 180° Peel force against SUS at23° C. (N/25 mm) | 14.8 | 18.5 | 18.6 | 18.6 |
| Evaluation | Peeling resistance | ∘ | ∘ | Δ | Δ |
| | Corner sealability-onset temperature (° C.) | 80 | 75 | 80 | 85 |
| | Housing sealability (corners not heated) | ∘ | ∘ | ∘ | ∘ |
| | Housing sealability (corners heated) | ∘∘ | ∘ | ∘ | ∘ |
| | Housing sealability (corners heated, long period of time) | ∘∘ | x | x | x |

TABLE 6

| | | | Comparative | Comparative | Comparative | Comparative |
|---|---|---|---|---|---|---|
| | | | Example 1 | Example 2 | Example 3 | Example 4 |
| First | Type | | PE | PE | PE | XL- |
| substrate | | | sheet EL | sheet EL | sheet EH | H#05002 |
| layer | Thickness (mm) | | 0.27 | 0.5 | 0.12 | 0.2 |
| | Water vapor transmission rate at 40° C. and 90% RH (g/(m² · day)) | | 1.7 | 0.66 | 1.1 | 29 |
| | 10% Thermal | MD | more | more | more | more |
| | shrinkage | | than 100 | than 100 | than 100 | than 100 |
| | temperature (° C.) | TD | more | more | more | 85 |
| | | | than 100 | than 100 | than 100 | |
| | Tensile storage elastic modulus | MD | 290 | 290 | 1600 | 19 |
| | at 25° C. (MPa) | TD | 250 | 250 | 1500 | 17 |
| | | Average value | 270 | 270 | 1550 | 18 |
| | | of MD and TD | | | | |
| | Average value of tensile storage elastic moduli × Thickness (MPa · mm) | | 73 | 140 | 190 | 3.6 |
| First | Type | | Adhesive | Adhesive | Adhesive | Adhesive |
| adhesive | | | layer A | layer A | layer A | layer A |
| layer | Thickness (mm) | | 0.075 | 0.075 | 0.075 | 0.075 |
| | Water vapor transmission rate at 40° C. and 90% RH (g/(m² · day)) | | 170 | 170 | 170 | 170 |
| | Tensile storage elastic modulus at 25° C. (MPa) | | 0.4 | 0.4 | 0.4 | 0.4 |
| | Tensile storage elastic modulus × Thickness (MPa · mm) | | 0.03 | 0.03 | 0.03 | 0.03 |
| Second | Type | | PX-40S | PX-40S | PX-40S | PX-40S |
| substrate | Inorganic layer | | None | None | None | None |
| layer | Thickness (mm) | | 0.025 | 0.025 | 0.025 | 0.025 |
| | Water vapor transmission rate at 40° C. and 90% RH (g/(m² · day)) | | 23 | 23 | 23 | 23 |
| | 10% Thermal shrinkage | MD | 68 | 68 | 68 | 68 |
| | temperature (° C.) | TD | 66 | 66 | 66 | 66 |
| | Tensile storage elastic modulus | MD | 2000 | 2000 | 2000 | 2000 |
| | at 25° C. (MPa) | TD | 1200 | 1200 | 1200 | 1200 |
| | | Average value | 1600 | 1600 | 1600 | 1600 |
| | | of MD and TD | | | | |
| | Average value of tensile storage elastic moduli × Thickness (MPa · mm) | | 40 | 40 | 40 | 40 |
| Second | Type | | Adhesive | Adhesive | Adhesive | Adhesive |
| adhesive | | | layer A | layer A | layer A | layer A |
| layer | Thickness (mm) | | 0.075 | 0.075 | 0.075 | 0.075 |
| | Water vapor transmission rate at 40° C. and 90% RH (g/(m² · day)) | | 170 | 170 | 170 | 170 |
| | Tensile storage elastic modulus at 25° C. (MPa) | | 0.4 | 0.4 | 0.4 | 0.4 |
| | Tensile storage elastic modulus × Thickness (MPa · mm) | | 0.03 | 0.03 | 0.03 | 0.03 |
| Third | Type | | — | — | — | — |
| substrate | Inorganic layer | | — | — | — | — |
| layer | Thickness (mm) | | — | — | — | — |
| | Water vapor transmission rate at 40° C. and 90% RH (g/(m² · day)) | | — | — | — | — |
| | 10% Thermal shrinkage | MD | — | — | — | — |
| | temperature (° C.) | TD | — | — | — | — |
| | Tensile storage | MD | — | — | — | — |
| | elastic modulus | TD | — | — | — | — |
| | at 25° C. (MPa) | Average value | — | — | — | — |
| | | of MD and TD | | | | |
| | Average value of tensile storage elastic moduli × Thickness (MPa · mm) | | — | — | — | — |
| Third | Type | | — | — | — | — |
| adhesive | Thickness (mm) | | — | — | — | — |
| layer | Water vapor transmission rate at 40° C. and 90% RH (g/(m² · day)) | | — | — | — | — |
| | Tensile storage elastic modulus at 25° C. (MPa) | | — | — | — | — |
| | Tensile storage elastic modulus × Thickness (MPa · mm) | | — | — | — | — |
| Adhesive tape | Thickness (mm) | | 0.445 | 0.675 | 0.295 | 0.375 |
| | Water vapor transmission rate at 40° C. and 90% RH (g/(m² · day)) | | 0.9 | 0.3 | 0.9 | 9.3 |
| | 10% Thermal | MD | more | more | more | 71 |
| | shrinkage | | than 100 | than 100 | than 100 | |
| | temperature | TD | more | more | more | 68 |
| | (° C.) | | than 100 | than 100 | than 100 | |
| | Bending modulus | MD | 4.0 | 15 | 2.2 | 0.28 |
| | (N · mm²) | TD | 2.9 | 11 | 1.6 | 0.24 |

| | | | | | |
|---|---|---|---|---|---|
| | 180° Peel force against SUS at 23° C. (N/25 mm) | 16.3 | 17.4 | 16.9 | 15.5 |
| Evaluation | Peeling resistance | x | x | x | ∘ |
| | Corner sealability-onset temperature (° C.) | more | more | more | 70 |
| | | than 100 | than 100 | than 100 | |
| | Housing sealability (corners not heated) | x | x | x | x |
| | Housing sealability (corners heated) | x | x | x | x |
| | Housing sealability (corners heated, long period of time) | — | — | — | — |

| | | Comparative | Comparative | Comparative |
|---|---|---|---|---|
| | | Example 5 | Example 6 | Example 7 |
| First | Type | XL- | XL- | PX- |
| substrate | | H#0180015 | H#0180015 | 40S |
| layer | Thickness (mm) | 0.15 | 0.15 | 0.025 |
| | Water vapor transmission rate at 40° C. and 90% RH (g/(m² · day)) | 19 | 19 | 23 |

| | | | | |
|---|---|---|---|---|
| 10% Thermal shrinkage | MD | 89 | 89 | 68 |
| temperature (° C.) | TD | 82 | 82 | 66 |
| Tensile storage elastic modulus | MD | 55 | 55 | 2000 |
| at 25° C. (MPa) | TD | 46 | 46 | 1200 |
| | Average value | 51 | 51 | 1600 |
| | of MD and TD | | | |

| | | | | |
|---|---|---|---|---|
| | Average value of tensile storage elastic moduli × Thickness (MPa · mm) | 7.7 | 7.7 | 40 |
| First | Type | Adhesive | Adhesive | Adhesive |
| adhesive | | layer D | layer A | layer A |
| layer | Thickness (mm) | 0.075 | 0.075 | 0.075 |
| | Water vapor transmission rate at 40° C. and 90% RH (g/(m² · day)) | 210 | 170 | 170 |
| | Tensile storage elastic modulus at 25° C. (MPa) | 1.3 | 0.4 | 0.4 |
| | Tensile storage elastic modulus × Thickness (MPa · mm) | 0.10 | 0.03 | 0.03 |
| Second | Type | PX-40S | — | — |
| substrate | Inorganic layer | None | — | — |
| layer | Thickness (mm) | 0.025 | — | — |
| | Water vapor transmission rate at 40° C. and 90% RH (g/(m² · day)) | 23 | — | — |

| | | | | |
|---|---|---|---|---|
| 10% Thermal shrinkage | MD | 68 | — | — |
| temperature (° C.) | TD | 66 | — | — |
| Tensile storage elastic modulus | MD | 2000 | — | — |
| at 25° C. (MPa) | TD | 1200 | — | — |
| | Average value | 1600 | — | — |
| | of MD and TD | | | |

| | | | | |
|---|---|---|---|---|
| | Average value of tensile storage elastic moduli × Thickness (MPa · mm) | 40 | — | — |
| Second | Type | Adhesive | — | — |
| adhesive | | layer D | | |
| layer | Thickness (mm) | 0.075 | — | — |
| | Water vapor transmission rate at 40° C. and 90% RH (g/(m² · day)) | 210 | — | — |
| | Tensile storage elastic modulus at 25° C. (MPa) | 1.3 | — | — |
| | Tensile storage elastic modulus × Thickness (MPa · mm) | 0.10 | — | — |
| Third | Type | — | — | — |
| substrate | Inorganic layer | — | — | — |
| layer | Thickness (mm) | — | — | — |
| | Water vapor transmission rate at 40° C. and 90% RH (g/(m² · day)) | — | — | — |

| | | | | |
|---|---|---|---|---|
| 10% Thermal shrinkage | MD | — | — | — |
| temperature (° C.) | TD | — | — | — |
| Tensile storage | MD | — | — | — |
| elastic modulus | TD | — | — | — |
| at 25° C. (MPa) | Average value | — | — | — |
| | of MD and TD | | | |

| | | | | |
|---|---|---|---|---|
| | Average value of tensile storage elastic moduli × Thickness (MPa · mm) | — | — | — |
| Third | Type | — | — | — |
| adhesive | Thickness (mm) | — | — | — |
| layer | Water vapor transmission rate at 40° C. and 90% RH (g/(m² · day)) | — | — | — |
| | Tensile storage elastic modulus at 25° C. (MPa) | — | — | — |
| | Tensile storage elastic modulus × Thickness (MPa · mm) | — | — | — |
| Adhesive tape | Thickness (mm) | 0.325 | 0.225 | 0.1 |
| | Water vapor transmission rate at 40° C. and 90% RH (g/(m² · day)) | 5.8 | 9.0 | 17 |

| | | | | |
|---|---|---|---|---|
| 10% Thermal | MD | 79 | 89 | 68 |
| shrinkage | | | | |
| temperature | TD | 82 | 82 | 66 |
| (° C.) | | | | |
| Bending modulus | MD | 0.41 | 0.032 | 0.0054 |
| (N · mm²) | TD | 0.33 | 0.027 | 0.0033 |

| | | | | |
|---|---|---|---|---|
| | 180° Peel force against SUS at 23° C. (N/25 mm) | 0.5 | 14.8 | 14.5 |
| Evaluation | Peeling resistance | x | ∘ | x |
| | Corner sealability-onset temperature (° C.) | 80 | 90 | 70 |
| | Housing sealability (corners not heated) | x | x | x |
| | Housing sealability (corners heated) | x | x | x |
| | Housing sealability (corners heated, long period of time) | — | — | — |

### INDUSTRIAL APPLICABILITY

The present invention can provide an adhesive tape excellent in barrier ability and L-shaped bending applicability. The present invention can also provide a method for manufacturing a hard disk drive excellent in sealability even in the case of sealing of a housing from the exterior of the housing, by use of the adhesive tape. The present invention can further provide a hard disk drive sealing structure body sufficiently sealed even in the case of sealing of a housing from the exterior of the housing.

### REFERENCE SIGNS LIST

tₙ′ thickness of n-th layer from outermost surface (n=1, 2 . . . )
hₙ: total of thicknesses of layers from layer on outermost surface to n-th layer (n=1, 2 . . . )
b: bending width
λ: distance from neutral axis to outermost surface of adhesive tape
0: lid of HDD
01: upper surface
02: lid corner
1: body of HDD
11: body bottom
12: body side wall
13: body corner
2: adhesive tape
21: adhesive tape used in evaluation of peeling resistance
22: adhesive tape used in evaluation of housing sealability (corner not heated)
31: lid of HDD used in evaluation of peeling resistance
32: body of HDD used in evaluation of peeling resistance
4: mold
41: upper surface of mold bottom
42: lower surface of mold bottom
43: mold side wall
5: mold used in evaluation of peeling resistance

1. An adhesive tape having
a water vapor transmission rate at 40° C. and 90% RH of 7.5 g/(m²·day) or less,
a bending rigidity at 25° C. at a bending width of 2.0 mm in at least one direction of a MD or a TD, of 1.0 N·mm² or less, and
a 180° peel force against SUS at 23° C. of 5.0 N/25 mm or more.

2. The adhesive tape according to claim 1,
wherein the bending rigidity at 25° C. at a bending width of 2.0 mm in at least one direction of the MD or the TD is 0.45 N·mm² or less.

3. The adhesive tape according to claim 1,
wherein the adhesive tape has a 10% thermal shrinkage temperature in at least one direction of the MD or the TD, of 95° C. or less.

4. The adhesive tape according to claim 1,
wherein the adhesive tape has two or more layers,
the two or more layers comprise at least a first substrate layer and a first adhesive layer, and
all the two or more layers of the adhesive tape satisfy that a product of a tensile storage elastic modulus at 25° C. and a thickness is 200 MPa·mm or less.

5. The adhesive tape according to claim 4,
wherein the first substrate layer has a water vapor transmission rate at 40° C. and 90% RH of 40 g/(m²·day) or less.

6. The adhesive tape according to claim 4,
wherein the first substrate layer contains a foam.

7. The adhesive tape according to claim 6,
wherein the foam comprises a polyolefin foam.

8. The adhesive tape according to claim 4,
wherein the first substrate layer has a 10% thermal shrinkage temperature in at least one direction of a MD or a TD, of 95° C. or less.

9. The adhesive tape according to claim 8,
wherein the first substrate layer has a 10% thermal shrinkage temperature in each of the MD and the TD, of 95° C. or less.

10. The adhesive tape according to claim 4,
wherein the adhesive tape has the first substrate layer, the first adhesive layer, a second substrate layer, and a second adhesive layer in the listed order,
the first substrate layer contains a foam,
the first substrate layer has a water vapor transmission rate at 40° C. and 90% RH of 40 g/(m²·day) or less,
the first substrate layer satisfies that a product of an average value of tensile storage elastic moduli at 25° C. in a MD and a TD and a thickness is 50 MPa·mm or less, and
the second substrate layer has a 10% thermal shrinkage temperature in at least one direction of a MD or a TD, of 95° C. or less.

11. The adhesive tape according to claim 4, further having an inorganic layer.

12. The adhesive tape according to claim 1,
wherein the adhesive tape has a thickness of 0.20 mm or more.

13. A method for manufacturing a hard disk drive having a body including a hard disk and a lid, the method comprising
a step of sealing the hard disk drive by applying the adhesive tape according to claim 1, to the body and the lid.

14. The method for manufacturing a hard disk drive according to claim 13,
wherein the step of sealing the hard disk drive includes folding and applying the adhesive tape from the lid to the body and then thermally shrinking the adhesive tape.

15. The method for manufacturing a hard disk drive according to claim 14,
wherein the body comprises a body bottom and a body side wall projected upward from the body bottom,
the lid has a structure so as to be attached onto the body side wall of the body, and
the step of sealing the hard disk drive includes
a step (I) of folding and applying the adhesive tape from the lid to the body side wall, and
a step (II) of thermally shrinking the adhesive tape after the step (I).

16. The method for manufacturing a hard disk drive according to claim 15,
wherein the body has a body corner on a surface of the body side wall, the surface being for attachment of the lid,
the lid has a lid corner to contact the body corner, and
the step (I) includes folding and applying the adhesive tape at least from the lid corner to the body corner and the step (II) includes thermally shrinking a portion of the adhesive tape, the portion being applied from the lid corner to the body corner.

17. The method for manufacturing a hard disk drive according to claim 15,
wherein the step (I) includes
attaching the lid onto the body side wall,
attaching the adhesive tape to an outer circumferential edge of an upper surface of the lid so that a portion of the adhesive tape is located outside the outer circumferential edge of the upper surface of the lid, and
pressing a mold against the lid, the mold containing a mold bottom and a mold side wall projected downward from an outer circumferential edge of the mold bottom, so that the upper surface of the lid and a lower surface of the mold bottom face each other, and folding the adhesive tape so that a portion of the adhesive tape, the portion being not in contact with the upper surface of the lid, is located between the mold side wall and the body side wall, to apply the adhesive tape to the body side wall, thereby bonding the body and the lid together.

18. The method for manufacturing a hard disk drive according to claim 17,
wherein, when the pressing is performed so that the upper surface of the lid and the lower surface of the mold bottom face each other, the mold is warmed to 35° C. or more and 60° C. or less and then used.

19. The method for manufacturing a hard disk drive according to claim 15,
wherein, in the step (I), the adhesive tape is in a frame form having a shape corresponding to an outer circumferential edge of an upper surface of the lid and an outer frame of the adhesive tape in the frame form is attached so as to be located outside the outer circumferential edge of the upper surface of the lid.

20. The method for manufacturing a hard disk drive according to claim 15,
wherein the step (II) includes thermally shrinking the adhesive tape by 10% or more in at least one direction of the MD or the TD at a temperature of the adhesive tape of 95° C. or less.

21. A hard disk drive sealing structure body comprising a body and a lid, the body and the lid being fixed with an adhesive tape interposed therebetween, the adhesive tape being thermally shrunk.
